(19) United States
(12) Patent Application Publication
(10) Pub. No.: US 2024/0137821 A1
(43) Pub. Date: Apr. 25, 2024

(54) METHOD AND APPRATUS FOR SWITCHING FROM MASTER NODE TO SECONDARY NODE IN COMMUNICATION SYSTEM

(71) Applicant: ELECTRONICS AND TELECOMMUNICATIONS RESEARCH INSTITUTE, Daejeon (KR)

(72) Inventors: Soon Gi PARK, Daejeon (KR); Young-Jo KO, Daejeon (KR); IL GYU KIM, Daejeon (KR); Jung Im KIM, Daejeon (KR); Jun Sik KIM, Daejeon (KR); Sung Cheol CHANG, Daejeon (KR); Sun Mi JUN, Daejeon (KR); Yong Seouk CHOI, Daejeon (KR)

(73) Assignee: ELECTRONICS AND TELECOMMUNICATIONS RESEARCH INSTITUTE, Daejeon (KR)

(21) Appl. No.: 18/492,479

(22) Filed: Oct. 22, 2023

(30) Foreign Application Priority Data
Oct. 23, 2022 (KR) 10-2022-0137790
Oct. 26, 2022 (KR) 10-2022-0140006
Oct. 18, 2023 (KR) 10-2023-0140431

(51) Int. Cl. H04W 36/00

(52) U.S. Cl. CPC H04W 36/00695

(57) ABSTRACT

Disclosed is a technique for switching from a master node to a secondary node in a communication system. A method of a first communication node may comprise: adding the first communication node as a primary secondary cell (PSCell) to a second communication node through dual connectivity (DC); generating a first user plane path for smart dynamic switching (SDS) and a first instance for supporting the first user plane path according to a request from the second communication node; transmitting information on the first user plane path and the first instance to a terminal; receiving user data based on the first user plane path from the terminal as the first instance; and transmitting the user data to a core network using the first user plane path.

### CROSS-REFERENCE TO RELATED APPLICATIONS

This application claims priority to Korean Patent Applications No. 10-2022-0137790, filed on Oct. 24, 2022, No. 10-2022-0140006, filed on Oct. 27, 2022, and No. 10-2023-0140431, filed on Oct. 19, 2023, with the Korean Intellectual Property Office (KIPO), the entire contents of which are hereby incorporated by reference.

### BACKGROUND

### 1. Technical Field

Example embodiments of the present invention relate to a technology for switching from a master node (MN) to a secondary node (SN) in a communication system, and more particularly, to a technology for switching from an MN to an SN in a communication system capable of providing smart dynamic switching (SDS) to a terminal that is connected to the MN and then connected to the SN through dual connectivity (DC).

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadB and (eMBB), Ultra-Reliable and Low-Latency Communication (URLLC), and massive Machine Type Communication (mMTC).

Meanwhile, in the 3^{rd} generation partnership project (3GPP) standard, reconfiguration including synchronization for changing a primary cell (PCell) and a primary secondary cell (PSCell) can be made through radio resource control (RRC) signaling in layer 3 (L3). In addition, a trigger for changing a serving cell can also be based on L3 measurement. In addition, reconfiguration including synchronization for release and addition of secondary cells (SCells) can also be made through the RRC signaling in the L3. During handover execution, the L1/L2 configuration can always be reset. Due to the resetting of the L1/L2 configuration, there can be a delay, overhead, and a disconnection time.

### SUMMARY

The present disclosure provides a method and apparatus for switching from a master node (MN) to a secondary node (SN) in a communication system that is capable of providing smart dynamic switching (SDS) to a terminal that is connected to the MN and then connected to the SN through dual connectivity (DC).

A method for switching from a master node to a secondary node in a communication system, according to a first exemplary embodiment of the present disclosure for achieving the above-described objective, as a method of a first communication node, may comprise: adding the first communication node as a primary secondary cell (PSCell) to a second communication node through dual connectivity (DC); generating a first user plane path for smart dynamic switching (SDS) and a first instance for supporting the first user plane path according to a request from the second communication node; transmitting information on the first user plane path and the first instance to a terminal; receiving user data based on the first user plane path from the terminal as the first instance; and transmitting the user data to a core network using the first user plane path.

The generating of the first user plane path for the SDS and the first instance for supporting the first user plane path according to the request from the second communication node may comprise: receiving an SDS preparation request including configuration information of the first user plane path and configuration information of the first instance for the SDS from the second communication node; generating the first user plane path according to the configuration information of the first user plane path; generating the first instance to support the first user plane path according to the configuration information of the first instance; and transmitting a smart dynamic preparation request acknowledge including information on the configured first instance to the second communication node.

The first instance may be a master cell group (MCG) radio link control (RLC) instance, and the first user plane path may be a user plane path generated between an MCG packet data convergence protocol (PDCP) instance of the second communication node and the MCG RLC instance.

The method may further comprise: receiving downlink user data of an MCG bearer from the MCG PDCP of the second communication node; and transmitting the downlink user data to the terminal using the MCG RLC.

The first instance may be an MCG RLC instance, and the first user plane path may be a user plane path generated between an MCG PDCP instance of the first communication node and the MCG RLC instance.

The method may further comprise: receiving downlink user data of an MCG bearer from a core network using the MCG PDCP instance; and transmitting the downlink user data to the terminal using the MCG RLC instance.

The request from the second communication node may further include a core network for the SDS, control interface configuration information of the first communication node, and bearer information terminated in the second communication node, and the method may further comprise: setting a control interface between the core network and the first communication node according to the control interface configuration information; and generating bearers terminated in the first communication node that replaces bearers terminated in the second communication node based on the bearer information terminated in the second communication node.

The control interface configuration information may include information on a first terminal identifier for the terminal generated by the second communication node and information on a second terminal identifier for the terminal generated by the core network, and the setting of the control interface between the core network and the first communication node according to the control interface configuration information may comprise: generating a third terminal identifier based on the first terminal identifier and the second terminal identifier; transmitting an SDS preparation request including the first terminal identifier, the second terminal identifier, and the third terminal identifier to the core network; and receiving mapping information between the second terminal identifier and the third terminal identifier from the core network.

The request from the second communication node may further include the control interface and information on second instances for supporting the bearers terminated in the first communication node, and the method may further comprise: generating the control interface and the second instances for supporting the bearers terminated in the first communication node; generating second user plane paths according to the second instances; transmitting the second user plane paths and the information on the second instances to the terminal; receiving the user data based on the second user plane paths from the terminal to the second instances; and transmitting the user data to the core network using the second user plane paths.

The second instances may be an MCG PDCP instance, a secondary cell group (SCG) PDCP instance, a split PDCP instance and an MCG RLC instance when the bearers terminated in the first communication node are an MCG bearer, an SCG bearer, and a split bearer, and the second user plane paths may include a path via the MCG PDCP instance and the MCG RLC instance, a path via the SCG PDCP instance and the SCG RLC instance, and a path via the split PDCP instance and the split RLC instance.

The method may further comprise: receiving downlink user data of an MCG bearer or an SCG bearer from the core network through the control interface; transmitting the downlink user data to the terminal; receiving downlink user data of a split bearer from the core network through the control interface; and transmitting the downlink user data to the terminal.

Meanwhile, a method for switching from a master node to a secondary node in a communication system, according to a second exemplary embodiment of the present disclosure for achieving the above-described objective, as a method of a terminal, may comprise: connecting the terminal to a first communication node added as a primary secondary cell (PSCell) to a second communication node through dual connectivity (DC); receiving a first user plane path for smart dynamic switching (SDS) and information on a first instance for supporting the first user plane path from the first communication node; and generating a second instance corresponding to the first instance.

The method may further comprise: generating user data via the first user plane path; and transmitting the user data as the first instance using the second instance.

The method may further comprise: receiving information on bearers terminated in the first communication node that replaces bearers terminated in the second communication node and information on second user plane paths related to bearers terminated in the first communication node; generating user data via the second user plane path; and transmitting the user data to the first communication node.

Meanwhile, an apparatus for switching from a master node to a secondary node in a communication system, according to a third exemplary embodiment of the present disclosure for achieving the above-described objective, as a first communication node, may comprise a processor, and the processor may operate to cause the first communication node to: be added, as a primary secondary cell (PSCell), to a second communication node through dual connectivity (DC); generate a first user plane path for smart dynamic switching (SDS) and a first instance for supporting the first user plane path according to a request from the second communication node; transmit the first user plane path and information on the first instance to a terminal; receive user data based on the first user plane path from the terminal as the first instance; and transmit the user data to a core network using the first user plane path.

In the generation of the first user plane path for the SDS and the first instance for supporting the first user plane path according to the request from the second communication node, the processor may operate to cause the first communication node to: receive an SDS preparation request including configuration information of the first user plane path and configuration information of the first instance for the SDS from the second communication node; generate the first user plane path according to the configuration information of the first user plane path; generate the first instance for supporting the first user plane path according to the configuration information of the first instance; and transmit a smart dynamic preparation request acknowledge including information on the configured first instance to the second communication node.

The request from the second communication node may further include a core network for the SDS, control interface configuration information of the first communication node, and bearer information terminated in the second communication node, and the processor may operate to cause the first communication node to: set the control interface between the core network and the first communication node according to the control interface configuration information; and generate bearers terminated in the first communication node that replaces bearers terminated in the second communication node based on the bearer information terminated in the second communication node.

The control interface configuration information may include information on a first terminal identifier for the terminal generated by the second communication node and information on a second terminal identifier for the terminal generated by the core network, and in the setting of the control interface between the core network and the first communication node according to the control interface configuration information, the processor may operate to cause the first communication node to: generate a third terminal identifier based on the first terminal identifier and the second terminal identifier; transmit an SDS preparation request including the first terminal identifier, the second terminal identifier, and the third terminal identifier to the core network; and receive mapping information between the second terminal identifier and the third terminal identifier from the core network.

According to the present disclosure, a terminal can perform smart dynamic switching while connected to a secondary node through dual connectivity, after initially connecting to a master node. Additionally, according to the present disclosure, the terminal can reduce delay, overhead, and interruption time through the smart dynamic switching. Additionally, according to the present disclosure, the terminal can minimize uplink/downlink capacity variations through the application of smart dynamic switching.

### BRIEF DESCRIPTION OF DRAWINGS

FIG. 1 is a conceptual diagram illustrating a first exemplary embodiment of a communication system.

FIG. 2 is a block diagram illustrating an exemplary embodiment of a communication node constituting a communication system.

FIG. 3 is a conceptual diagram illustrating a first embodiment of a method of operating a single PCell in a communication system.

FIG. 4 is a conceptual diagram illustrating a first embodiment of the PCell re-establishment procedure in the master node.

FIG. 5A is a conceptual diagram illustrating a first embodiment of a communication environment in which the method of switching from an MN to an SN is applied.

FIG. 5B is a conceptual diagram illustrating a first embodiment of the communication environment in which the method of switching from an MN to an SN is applied.

FIG. 5C is a conceptual diagram illustrating a third embodiment of the communication environment in which the method of switching from an MN to an SN is applied.

FIG. 5D is a conceptual diagram illustrating a fourth embodiment of the communication environment in which the method of switching from an MN to an SN is applied.

FIG. 5E is a conceptual diagram illustrating a fifth embodiment of the communication environment in which the method of switching from an MN to an SN is applied.

FIG. 5F is a conceptual diagram illustrating a sixth embodiment of the communication environment in which the method of switching from an MN to an SN is applied.

FIG. 5G is a conceptual diagram illustrating a seventh embodiment of the communication environment in which the method of switching from an MN to an SN is applied.

FIG. 6 is a conceptual diagram illustrating a first embodiment of a CP in a single control plane operation method.

FIG. 7 is a conceptual diagram illustrating a first embodiment of the UP in the single control plane operation method.

FIG. 8 is a conceptual diagram illustrating a first embodiment of message exchange in a control interface.

FIG. 9 is a conceptual diagram illustrating a first embodiment of the UP information.

FIG. 10A is a conceptual diagram illustrating a first embodiment of UP paths between the MN and the CN and the MN and the SN

FIG. 10B is a conceptual diagram illustrating a second embodiment of UP paths between the MN and the CN and the MN and the SN.

FIG. 10C is a conceptual diagram illustrating a third embodiment of UP paths between the MN and the CN and the MN and the SN.

FIG. 10D is a conceptual diagram illustrating a fourth embodiment of UP paths between the MN and the CN and the MN and the SN.

FIG. 10E is a conceptual diagram illustrating a fifth embodiment of UP paths between the MN and the CN and the MN and the SN.

FIG. 10F is a conceptual diagram illustrating a sixth embodiment of UP paths between the MN and the CN and the MN and the SN.

FIG. 10G is a conceptual diagram illustrating a seventh embodiment of UP paths between the MN and the CN and the MN and the SN.

FIG. 10H is a conceptual diagram illustrating an eighth embodiment of UP paths between the MN and the CN and the MN and the SN.

FIG. 11 is a conceptual diagram illustrating a first embodiment of the information exchange for connection between the MN and the SN.

FIG. 12 is a conceptual diagram illustrating a second embodiment of the information exchange for connection between the MN and the SN.

FIG. 13 is a conceptual diagram illustrating a first embodiment of a change in the control interface for switching from the MN to the SN.

FIG. 14 is a conceptual diagram illustrating a second embodiment of the UP in the single control plane operation method.

FIG. 15A is a conceptual diagram illustrating a first embodiment of UP paths between the MN and the CN and the MN and the SN for switching.

FIG. 15B is a conceptual diagram illustrating a second embodiment of UP paths between the MN and the CN and the MN and the SN for switching.

FIG. 15C is a conceptual diagram illustrating a third embodiment of UP paths between the MN and the CN and the MN and the SN for switching.

FIG. 15D is a conceptual diagram illustrating a fourth embodiment of UP paths between the MN and the CN and the MN and the SN for switching.

FIG. 15E is a conceptual diagram illustrating a fifth embodiment of UP paths between the MN and the CN and the MN and the SN for switching.

FIG. 15F is a conceptual diagram illustrating a sixth embodiment of UP paths between the MN and the CN and the MN and the SN for switching.

FIG. 15G is a conceptual diagram illustrating a seventh embodiment of UP paths between the MN and the CN and the MN and the SN for switching.

FIG. 15H is a conceptual diagram illustrating an eighth embodiment of UP paths between the MN and the CN and the MN and the SN for switching.

FIG. 16 is a conceptual diagram illustrating a third embodiment of the UP in the single control plane operation method.

FIG. 17A is a conceptual diagram illustrating a first embodiment of additional paths of the UP between the MN and the CN and the MN and the SN for switching.

FIG. 17B is a conceptual diagram illustrating a second embodiment of additional paths of the UP between the MN and the CN and the MN and the SN for switching.

FIG. 17C is a conceptual diagram illustrating a third embodiment of additional paths of the UP between the MN and the CN and the MN and the SN for switching.

FIG. 17D is a conceptual diagram illustrating a fourth embodiment of additional paths of the UP between the MN and the CN and the MN and the SN for switching.

FIG. 17E is a conceptual diagram illustrating a fifth embodiment of additional paths of the UP between the MN and the CN and the MN and the SN for switching.

FIG. 17F is a conceptual diagram illustrating a sixth embodiment of additional paths of the UP between the MN and the CN and the MN and the SN for switching.

FIG. 17G is a conceptual diagram illustrating a seventh embodiment of UP paths between the MN and the CN and the MN and the SN for switching.

FIG. 17H is a conceptual diagram illustrating an eighth embodiment of additional paths of the UP between the MN and the CN and the MN and the SN for switching.

FIG. 18 is a flowchart illustrating a first embodiment of a processing of transmitting user data.

FIG. 19 is a flowchart illustrating a second embodiment of the process of transmitting user data.

FIG. 20 is a flowchart illustrating a third embodiment of the process of transmitting user data.

FIG. 21 is a flowchart illustrating a fourth embodiment of the process of transmitting user data.

FIG. 22 is a flowchart illustrating a fifth embodiment of the process of transmitting user data.

FIG. 23 is a flowchart illustrating a sixth embodiment of the process of transmitting user data.

FIG. 24 is a flowchart illustrating a seventh embodiment of the process of transmitting user data.

FIG. 25 is a flowchart illustrating an eighth embodiment of the process of transmitting user data.

FIG. 26 is a flowchart illustrating a fifth embodiment of the process of transmitting user data.

FIG. 27 is a flowchart illustrating a tenth embodiment of the process of transmitting user data.

FIG. 28 is a flowchart illustrating an eleventh embodiment of the process of transmitting user data.

FIG. 29 is a flowchart illustrating a twelfth embodiment of the process of transmitting user data.

FIG. 30 is a conceptual diagram illustrating a first embodiment of usable message types of a control interface.

FIG. 31 is a flowchart illustrating a first embodiment of the method of switching from an MN to an SN in a communication system.

FIG. 32 is a flowchart illustrating a first embodiment of the node switch preparation operation of FIG. 31.

FIG. 33 is a flowchart illustrating a first embodiment of the node switching action operation of FIG. 31.

FIG. 34 is a flowchart illustrating a first embodiment of the node switching complete operation of FIG. 31.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the FIGS. and the repetitive description thereof will be omitted.

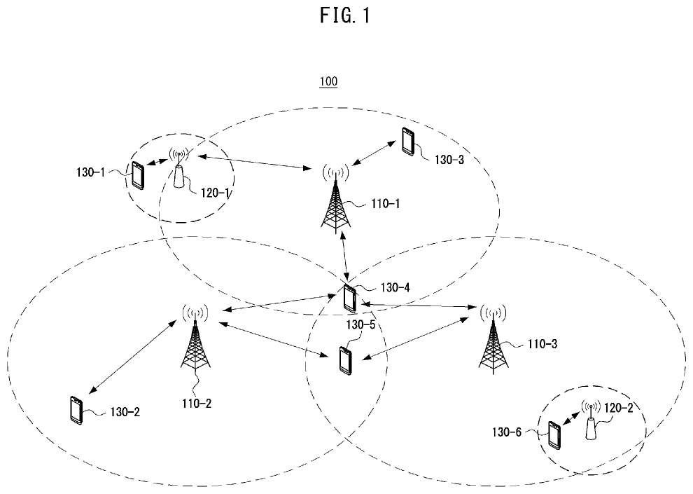

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support at least one communication protocol. For example, each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

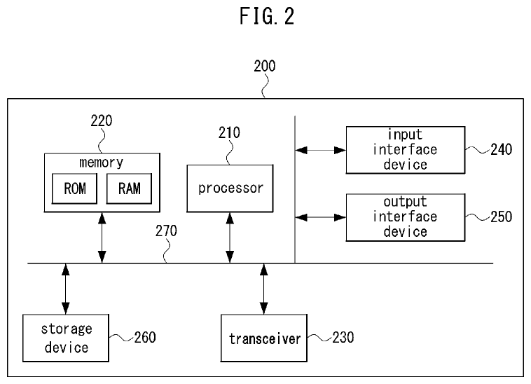

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270. However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of UEs 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to the cell coverage of the first base station 110-1. Also, the second UE 130-2, the fourth UE 130-4, and the fifth UE 130-5 may belong to the cell coverage of the second base station 110-2. Also, the fifth base station 120-2, the fourth UE 130-4, the fifth UE 130-5, and the sixth UE 130-6 may belong to the cell coverage of the third base station 110-3. Also, the first UE 130-1 may belong to the cell coverage of the fourth base station 120-1, and the sixth UE 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), base transceiver station (BTS), radio base station, radio transceiver, access point (AP), access node, road side unit (RSU), digital unit (DU), cloud digital unit (CDU), radio remote head (RRH), radio unit (UR), transmission point (TP), transmission and reception point (TRP), relay node, or the like. Each of the plurality of UEs 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding UE 130-1, 130-2, 130-3, 130-4, 130-5, or 130-6, and transmit a signal received from the corresponding UE 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of UEs 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, in the 3rd generation partnership project (3GPP) standard, reconfiguration including synchronization for changing a primary cell (PCell) and a primary secondary cell (PSCell) can be achieved through radio resource control (RRC) signaling in layer 3 (L3). In addition, a trigger for changing a serving cell can also be based on L3 measurement. In addition, reconfiguration including synchronization for release and addition of secondary cells (SCells) can also be made through the RRC signaling in the L3.

During handover execution, the L1/L2 configuration can always be reset. Due to the resetting of the L1/L2 configuration, there can be delays, overhead, and disconnection times. To solve this problem, in the 3GPP Radio Access Network Technology Conference, L1/L2-based mobility management can be discussed as an additional new radio (NR) mobility enhancement work item (WI) in intra-distributed unit (DU), inter-DU, intra-central unit (CU), and intra-base station (B S) separately from L3-based mobility management, and the discussion can be finished at the end of 2023. In this regard, the 3GPP Radio Access Network Technology Conference can discuss a method of switching from a master node (MN) to a secondary node (SN) as a subordinate priority of the NR mobility enhancement WI.

The method of switching from a master node to a secondary node according to the present disclosure can be introduced after Release 19 even if it is not discussed in additional NR mobility enhancement items of Release 18. In a multi-connectivity situation, the MN can have mobility. In this case, the SN in a coverage hole of the MN can be stable. In this situation, a terminal can reduce variability of capacity by switching from the MN to the SN, secure stability according to movement of the MN PCell, and reduce degradation in performance due to instability of the MN PCell. The 3GPP can propose a method of operating a single PCell in cellular mobile communications.

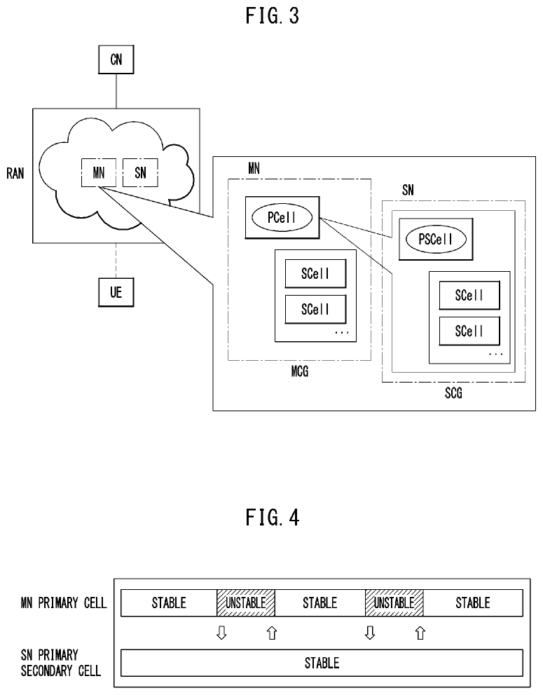

FIG. 3 is a conceptual diagram illustrating a first embodiment of a method of operating a single PCell in a communication system.

Referring to FIG. 3, in a single PCell operation method, a single control plane may include an MN-user equipment (MN-UE) control interface of one radio access network (RAN) and an MN-core network (MN-CN) control interface of one RAN. In this method of operating a single PCell, the PCell may be determined through an initial access to the MN of the terminal. In addition, in the method of operating a single PCell, the SCell may be added to the same node (in other words, MN) as the PCell through carrier aggregation (CA) based on the PCell. In addition, in the method of operating a single PCell, the PSCell may be added to a node (in other words, SN) different from the SCell through dual connectivity (DC).

In addition, the PSCell may add the SCell to the same node as the PSCell through the carrier aggregation. In this case, one PCell may be associated with SCells added through the carrier aggregation, a PSCell added through dual connectivity, and SCells added based on the PSCell. In this multi-connectivity situation, the quality of the MN PCell may be an anchor of overall mobility. In addition, the quality of the SN PSCell may be a standard for addition/change/deletion of the SN. The PCell and PSCell may be called special cells (SpCell).

Meanwhile, a master cell group (MCG) and a secondary cell group (SCG) may be defined for the dual connectivity. The MCG may include the currently connected MN PCell and SCells. The SCG may include the currently connected SN PSCell and SCells. In this case, a candidate MCG list may be set to change the current MN for conditional handover (CHO). In addition, the SCG list may be set to change the current SN for conditional PSCell change & addition (CPCA).

However, in the 3GPP standard, reconfiguration including synchronization for changing the PCell and the PSCell may be achieved through RRC signaling in L3. In addition, a trigger for changing a serving cell may also be based on L3 measurement. In addition, the reconfiguration including the synchronization for the release and addition of the SCells may also be achieved through the RRC signaling in the L3.

During the handover execution, the L1/L2 configuration may always be reset. Due to the resetting of the L1/L2 configuration, there may be delays, overhead, and disconnection times. However, a method of changing a connection by recycling a set configuration of intra-DU, inter-DU, intra-CU, and intra-BS may minimize delay, overhead, and disconnection time, and may minimize variability of capacity provided to a terminal.

In the present disclosure, the terminal may be connected to the SN through the dual connectivity while being connected to the MN. In this case, an MN PCell re-establishment procedure may be performed due to the movement possibility of the MN. Alternatively, the MN PCell re-establishment may be achieved by radio link failure (RLF), handover failure (HOF), or beam failure (BF) of the MN PCell. In this situation, the quality of the SN may be excellent. In this situation, the terminal may temporarily perform smart dynamic switching (SDS) from the MN to the SN. Through this process, the terminal may eliminate the delay, the overhead, and the disconnection time. In addition, the terminal may reduce variability of uplink (UL)/downlink (DL) capacity.

FIG. 4 is a conceptual diagram illustrating a first embodiment of the PCell re-establishment procedure in the master node.

Referring to FIG. 4, the SN connection may be automatically released in the MN PCell re-establishment procedure due to the HOF/RLF/BF of the MN PCell. In this case, it may be difficult to maintain a constant data rate because wireless capacity provided from the SN to the terminal may not be utilized. In addition, the HOF/RLF may occur because the wireless capacity provided by the SN to the terminal may not be utilized. Of course, the HOF/RLF may not occur in a successful handover when there is the probability of handover in the MN PCell.

In this situation, the quality of SN may be excellent. Then, the terminal may keep the wireless capacity constant by switching from the MN to the SN. In addition, the terminal may prevent pos-risks caused by the MN handover in advance by switching from the MN to the SN. In this case, the RAN may transmit packets to either the MN or SN through the RAN and the RAN interface with the MCG/SCG/split bearer. Alternatively, the RAN may distribute and transmit the packets to both the MN and SN using the MCG/SCG/split bearer. Alternatively, the RAN may distribute and transmit packets to both the MN and SN using the MCG/SCG/split bearer. In this case, the CN may switch packets from the MN to the SN. Alternatively, the CN may perform bicasting with (in other words, transmit redundantly) packets to the MN and the SN. Alternatively, the CN may distribute packets to the MN and the SN.

Here, the RAN and CN may switch packets and redundantly transmit (in other words, perform bicasting with) packets. In conclusion, the PCell re-establishment may occur due to the instability of the MN Pcell. For each such event, the network may not provide a certain data capacity to the terminal for a certain period of time required for the Pcell re-establishment and subsequent carrier aggregation of MN/dual connectivity procedure of SN.

Originally, the RAN MCG bearer may be connected wirelessly through the terminal and MN. The RAN MCG bearer may be connected wirelessly through the terminal and SN. However, in the present disclosure, the RAN MCG bearer can be wirelessly connected to the terminal through the SN for the SDS from the MN to the SN. Each of the RAN MCG/SCG/split bearers may be connected to the MN in the CN and network connection, and may also be connected to the SN.

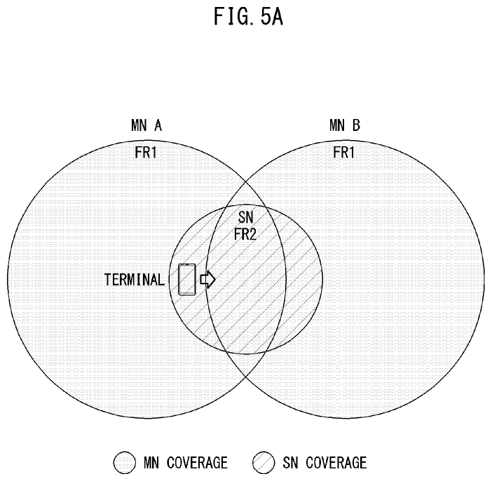

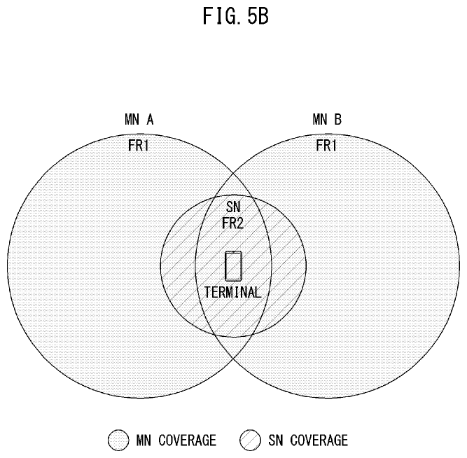

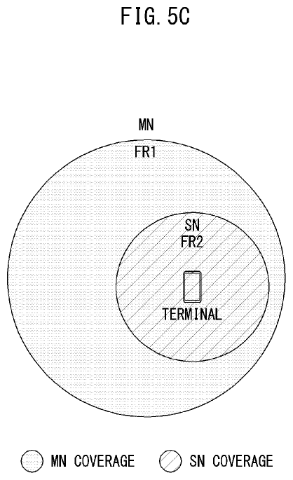

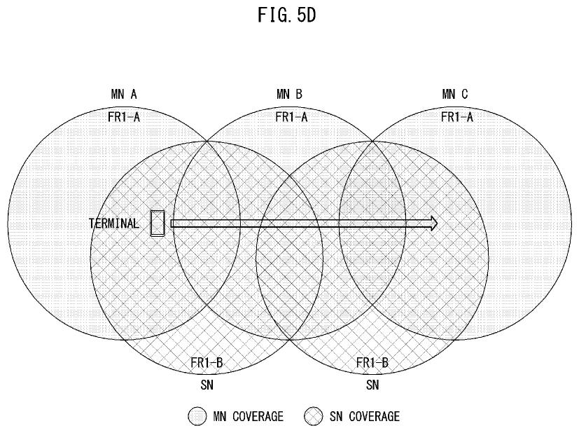

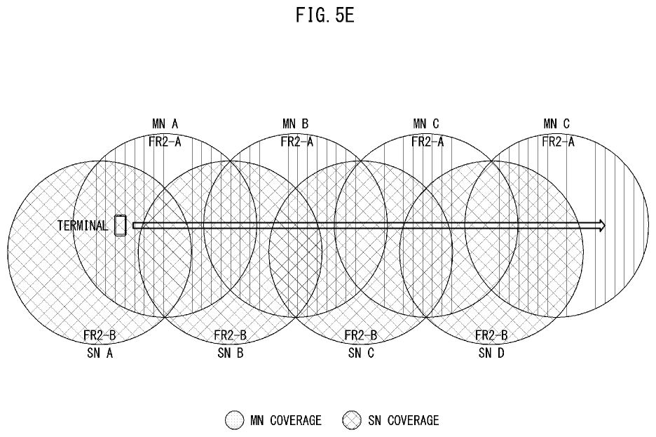

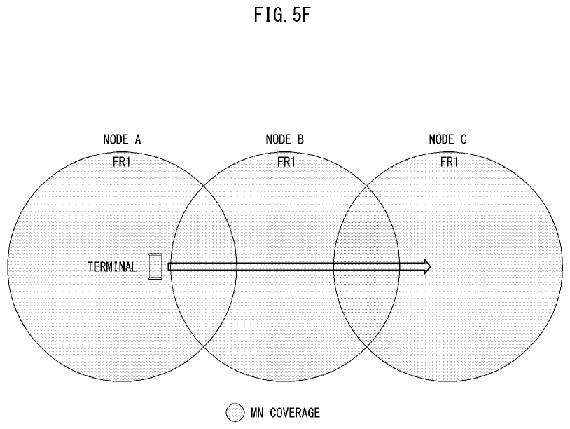

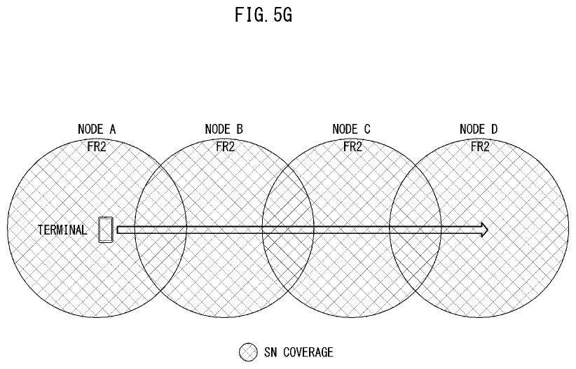

FIG. 5A is a conceptual diagram illustrating a first embodiment of a communication environment in which the method of switching from an MN to an SN is applied.

Referring to FIG. 5A, MN A and MN B may use a frequency in a frequency range (FR) 1. Accordingly, coverages of MN A and NM B may be larger than SN coverage. The SN may use a frequency in FR2. Of course, the SN may use the frequency in the FR2. Alternatively, the SN may use a frequency of terahertz (THz). Accordingly, the SN coverage may be smaller than that of the MN A and MN B.

The SN is used as a capacity layer and may be used for capacity boosting in a specific hotspot area. However, in a certain specific area, not only the coverage but also the capacity layer may be configured seamlessly. The terminal may perform a handover at a boundary between the coverages of the MN A and MN B while the MN A and SN are connected. In this case, the terminal may enter a center of the SN coverage.

FIG. 5B is a conceptual diagram illustrating a first embodiment of the communication environment in which the method of switching from an MN to an SN is applied.

Referring to FIG. 5B, the MN A and MN B may use the frequency in the FR 1. Accordingly, the coverages of the MN A and NM B may be larger than that of the SN. The SN may use the frequency in the FR2. Of course, the SN may use the frequency in the FR2. Alternatively, the SN may use the frequency of THz. Accordingly, the SN coverage may be smaller than those of the MN A and MN B.

The SN is used as the capacity layer and may be used for the capacity boosting in the specific hotspot area. However, in a certain specific area, not only the coverage but also the capacity layer may be configured seamlessly. Meanwhile, although the terminal is at the boundary between the coverages of the MN A and the MN B, it may be necessary to perform the MN PCell re-establishment procedure due to a coverage hole at the FR1 frequency of the coverage of the MN A. In this case, the terminal may enter a center of the SN coverage.

FIG. 5C is a conceptual diagram illustrating a third embodiment of the communication environment in which the method of switching from an MN to an SN is applied.

Referring to FIG. 5C, the MN may use the frequency in the FR1. Accordingly, the MN coverage may be larger than that of the SN coverage. The SN may use the frequency in the FR2. Of course, the SN may use the frequency in the FR2. Alternatively, the SN may use the frequency of THz. Accordingly, the SN coverage may be larger than those of the MN A and MN B. The SN is used as the capacity layer and may be used for the capacity boosting in the specific hotspot area. However, in a certain specific area, not only the coverage but also the capacity layer may be configured seamlessly. Meanwhile, the terminal is within the MN coverage, but can be located in the coverage hole of the MN FR1 and at the same time the center of the SN coverage.

FIG. 5D is a conceptual diagram illustrating a fourth embodiment of the communication environment in which the method of switching from an MN to an SN is applied.

Referring to FIG. 5D, the MN A to MN C may use the frequency in the FR 1. The SNs may use the frequency in the FR1. Accordingly, the coverages of the SNs may have a size similar to those of MN A to MN C. In this case, the MNs may consecutively configure the coverage layer using the frequency in the FR1. The SNs may consecutively configure the coverage layer using the frequency in the FR1. In this case, the terminal may switch from the MN to the SN in a coverage border area of the MNs. The terminal may switch from the SN to the MN in a coverage border area of the SNs. When the terminal switches in this way, the handover procedure can be omitted.

FIG. 5E is a conceptual diagram illustrating a fifth embodiment of the communication environment in which the method of switching from an MN to an SN is applied.

Referring to FIG. 5D, the MN A to MN D may use the frequency in the FR 1. SN A to SN D may use the frequency in the FR2. Accordingly, the coverages of the SNs may have a size similar to those of MN A to MN D. In this case, the MNs may consecutively configure the coverage layer using the frequency in the FR2. The SNs may consecutively configure the coverage layer using the frequency in the FR2. In this case, the terminal may switch from the MN to the SN in the coverage border area of the MNs. The terminal may switch from the SN to the MN in the coverage border area of the SNs. When the terminal switches in this way, the handover procedure can be omitted.

Meanwhile, in FIGS. 5D and 5E, although the coverage layers are divided using the MN and SN, special cells (in other words, PCell and PSCell) may use different frequencies to configure two different coverage layers. In addition, the special cell may adopt an overlapping cell structure so that a border area (in other words, handover area) of one layer does not become a border area of another layer. Accordingly, the terminal may minimize the delay/overhead/disconnection time and capacity change due to the HOF/RLF/BF and PCell re-establishment procedures according to the switching method instead of the handover procedure.

FIG. 5F is a conceptual diagram illustrating a sixth embodiment of the communication environment in which the method of switching from an MN to an SN is applied.

Referring to FIG. 5F, node A to node C may use the frequency in the FR 1. The nodes may consecutively configure the coverage layer using the frequency in the FR1.

FIG. 5G is a conceptual diagram illustrating a seventh embodiment of the communication environment in which the method of switching from an MN to an SN is applied.

Referring to FIG. 5G, node A to node D may use the frequency in the FR 2. The nodes may consecutively configure the coverage layer using the frequency in the FR2.

In FIGS. 5F and 5G, the coverage layer has the overlapping cell structure as in FIGS. 5D and 5E, but may be applied within one coverage layer like the existing cell planning, rather than the method of configuring two layers. In this case, a node to which the terminal is connected may be the MN. A node (in other words, target node (cell)) to which the terminal is likely to be connected next may be the SN. The terminal may be connected in a multi-connected manner at the beginning of entry into the coverage layer of the node. In this case, when the quality of the connected MN PCell decreases, the terminal may perform the SDS from the MN to the SN. Alternatively, when there is the possibility of handover of the connected MN PCell, the terminal may perform the SDS from the MN to the SN.

Then, the existing MN may be the SN, and the existing SN may be the MN. Accordingly, the terminal may avoid wireless connection instability and re-establishment due to the handover of the existing MN PCell. Accordingly, the terminal may achieve two effects at the same time: mobility robustness like the CHO is achieved and a user plane (UP) interruption time does not exist on the UP like a dual active protocol stack (DAPS).

In other words, the terminal may apply the SDS from the MN to the SN in the situation of FIGS. 5F and 5G rather than the existing handover method on a control plane (CP) and the UP. As a result, the mobility robustness may be achieved in the border area. In addition, the UP interruption time in the border area may have a zero UP interruption time. Here, the zero UP interruption time may be a case where the DL may be just zero, and as a result, the interruption times of the DL and UL may be zero. In this case, nodes may prevent a decrease in capacity at a cell edge, thereby providing uniform quality of service (QoS). Considering these characteristics, the method of achieving mobility through SDS from an MN to an SN in one coverage layer may be referred to as smooth fading-in/out mobility.

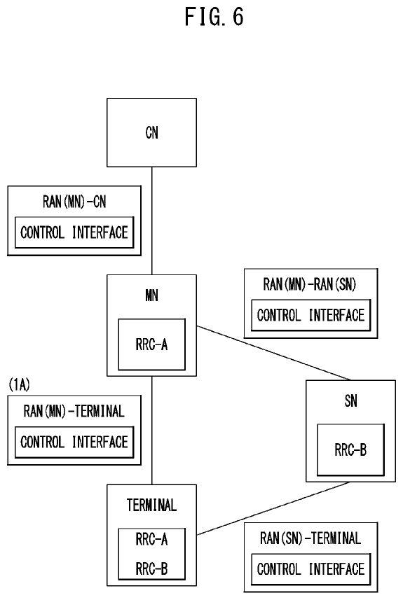

FIG. 6 is a conceptual diagram illustrating a first embodiment of a CP in a single control plane operation method.

Referring to FIG. 6, in the 3GPP single control plane operation method, a single control plane may have two control interfaces. In this case, one may be an MN-CN control interface of RAN on a control plane of the MN and the CN. For example, this control interface may be next generation application protocol (NGAP) in a new radio (NR), and may be an S1 application protocol (S1AP) in long term evolution (LTE). The other may be an MN-terminal control interface of the RAN between the MN and the terminal. For example, this control interface may be the RRC in the NR and the RRC in the LTE.

In addition, from the SN perspective, the SN may be connected to the MN through the dual connectivity. In this case, the control plane may additionally have an SN control interface of an MN-RAN of the RAN. In addition, the control plane may additionally have an SN-terminal control interface of the RAN between the terminal and the SN. For example, this control interface may be the RRC in the NR and the RRC in the LTE. The terminal may have RRC-A and RRC-B which are independent from each other. Each of the RRC-A and RRC-B, which are independent from each other, may perform radio control communication with an RRC-A of the MN and an RRC-B of the SN. In this case, an RRC-A of the terminal may be a master RRC.

The terminal may not transmit an RRC-B message of the terminal directly to the RRC-B of the MN through the SN-terminal control interface of the RAN for any special purpose or in situations of radio instability between the SN and the terminal. The terminal may transmit the RRC-B message of the terminal to an RRC-A of the MN through an MN-terminal control interface of the RAN by putting the RRC-B message of the terminal in a container of an RRC-A message of the MN. Then, the MN may transmit the RRC-B message from the MN to the SN again using an SN interface message container of the MN-RAN of the RAN. In this way, RRC-B of the SN may indirectly receive the RRC-B message.

Likewise, the terminal may not directly transmit the RRC-A message of the terminal to MN RRC-A through the MN-terminal control interface of the RAN for some special purposes or in the situation of radio instability between the MN and the terminal. The terminal may transmit the RRC-A message of the terminal to an RRC-B of the SN through an SN-terminal control interface of the RAN by putting the RRC-A message of the terminal in a container of an RRC-B message of the SN. Then, the SN may transmit an RRC-A message from the SN to the MN again using an SN interface message container of the MN-RAN of the RAN. In this way, the RRC-A of the MN may indirectly receive the RRC-A message. The terminal may mainly use signaling radio bearer (SRB) 3 when indirectly transmitting these two UL messages.

The RRC-A of the MN may directly transmit the RRC-A message to the RRC-A of the terminal through the MN-terminal control interface of the RAN. In this case, the RRC-A of the MN may use SRB0/1/2 of the SN. However, for special purposes in some situations, the RRC-A of the MN may transmit the RRC-A message of the MN to the SN by putting the RRC-A message in the container of the message through the SN control interface of the MN-RAN of the RAN. Then, the RRC-B of the SN may be generally transmitted to the terminal as an RRC-B SRB3 of the SN through the SN-terminal control interface of the RAN by putting the received RRC-A message in the container of the RRC-B message. Then, the terminal may indirectly receive the RRC-A message of the MN.

The RRC-B of the SN may directly transmit the RRC-B message to an RRC-B of the terminal through the SN-terminal control interface of the RAN. In this case, the RRC-B of the SN may use the SRB0/1/2 of the SN. However, for special purposes in some situations, the RRC-B of the SN may be transmitted to the MN by putting the RRC-B message in the container of the message through the SN control interface of the MN-RAN of the RAN. The RRC-A of the MN may generally be transmitted to the terminal as the MN RRC-A SRB3 through the RRC-A message of the RAN by putting the received RRC-B message in the container of the RRC-A message. In this way, the terminal may indirectly receive the RRC-B message of the SN.

In FIG. 6, a unique identifier (ID) on the MN-CN control interface of the RAN for the corresponding terminal may be divided into a pair of the RAN UE NGAP ID/access and mobility management function (AMF) UE NGAP ID. In this case, the RAN UE NGAP ID may be first generated by the MN. The AMF UE NGAP ID may be first generated by the AMF of the CN. In FIG. 6, the unique ID on the SN control interface of the MN-RAN of the RAN for the corresponding terminal is divided into a pair of M-NG-RAN node UE Xn application protocol (XnAP) ID/S-NG-RAN node UE XnAP ID. The M-NG-RAN node UE XnAP ID may be first generated by the MN, and the S-NG-RAN node UE XnAP ID may be first generated by the SN.

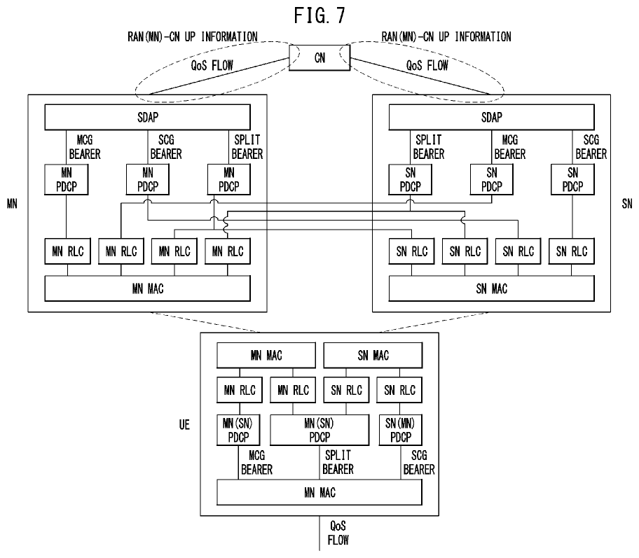

FIG. 7 is a conceptual diagram illustrating a first embodiment of the UP in the single control plane operation method.

Referring to FIG. 7, in the single control plane operation method, the MN may include service data association protocols (SDAPs), MN packet data convergence protocols (PDCPs), MN radio link controls (RLCs), and MN medium access control (MAC). The SN may include SDAP, SN PDCPs, SN RLCs, and SN MAC. The terminal may include the MN MAC/SN MAC, the MN RLCs/SN RLCs, the MN(SN) PDCPs/SN(MN) PDCP, and the SDAP. Each bearer may be divided into three types. First, the bearer may be an MCG bearer. Second, the bearer may be an SCG bearer. Third, the bearer may be a split bearer. This division may be a division in the wireless transmission path.

The MCG bearer may be a bearer that wirelessly transmits a packet through the MN RLC/MN MAC and transmits the packet to the UE MN MAC/UE MN RLC, or conversely, receives the packet through this path. For any one specific MCG bearer, the corresponding PDCP may be MN-terminated in use the MN PDCP, or SN-terminated in use the SN PDCP. The CN does not recognize that the bearer is the MCG bearer, but may transmit QoS flows related to the MCG bearer to the MN or to the SN based on MN-CN UP information of the RAN determined through the MN-CN control interface of the RAN, or receive the QoS flows from the SN.

The SCG bearer may be a bearer that wirelessly transmits a packet through the SN RLC/SN MAC and transmits the packet to the UE SN MAC/UE SN RLC, or conversely, receives the packet through this path. For any one specific SCG bearer, the corresponding PDCP may be MN terminated in use of the MN PDCP, or SN terminated in use of the SN PDCP. The CN does not recognize that the bearer is the SCG bearer, but may transmit QoS flows related to the SCG bearer to the MN or to the SN based on MN-CN UP information of the RAN determined through the MN-CN control interface of the RAN, or receive the QoS flows from the SN.

The split bearer may have two paths of the UE MN MAC/UE MN RLC which transmits the packet wirelessly through the MN RLC/MN MAC, or the UE SN MAC/UE SN RLC which transmits the packet wirelessly through the SN RLC/SN MAC. The split bearer may be a bearer that uses both paths to simultaneously transmit or receive a packet in duplicate or by sweeping to one path. For any one specific split bearer, the corresponding PDCP may be MN terminated in use of the MN PDCP, or SN terminated in use of the SN PDCP. The CN does not recognize that the bearer is the split bearer, but may transmit QoS flows related to the split bearer to the MN or to the SN based on the MN-CN UP information of the RAN determined through the MN-CN control interface of the RAN, or receive the QoS flows from the SN. Next, the present disclosure may describe how ID and UP path for a unique CP connection to the terminal in the CP of FIG. 6 and the UP of FIG. 7 are exchanged and configured in an RAN-CN control interface and an RAN-RAN control interface.

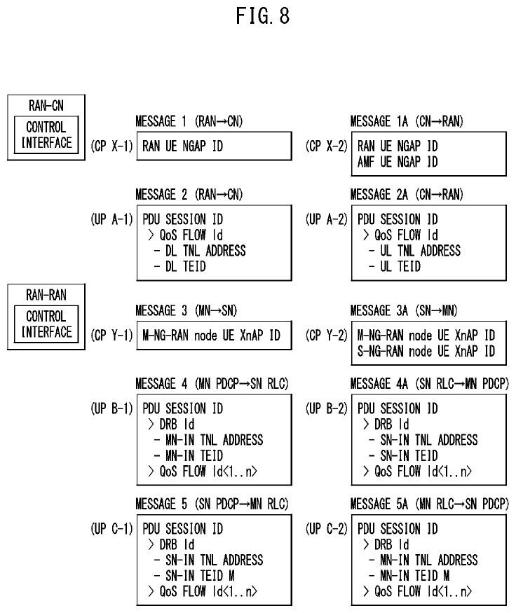

FIG. 8 is a conceptual diagram illustrating a first embodiment of message exchange in a control interface.

Referring to FIG. 8, in the RAN-CN control interface, any node in the RAN initially may generate a unique RAN UE NGAP ID (in other words, CP X-1) for the corresponding terminal, and include the generated unique RAN UE NGAP ID in message 1 and transmit the message 1 to the CN. Then, the CN generates a unique AMF UE NGAP ID for the corresponding terminal and may include information (in other words, CP-X2) including the RAN UE NGAP ID received from the RAN and the AMF UE NGAP ID issued by the CN in message 1A and may transmit the message 1A to the RAN. Thereafter, an RAN-CN control interface message for the terminal may necessarily include the RAN UE NGAP ID and the AMF UE NGAP ID regardless of a transmission direction. Through this, it can be seen that the message including the CP-X2 transmitted from the RAN and CN is the RAN-CN control interface message for the corresponding terminal.

Meanwhile, in the RAN-CN control interface, the RAN and CN may exchange message 2 and message 2A. Through this exchange, any node in the CN and RAN may know both a UL packet transmission end point to the CN and a DL packet transmission end point to any node (e.g., MN or SN) in the RAN. Here, the UL packet transmission end point may be a UL transport network layer (TNL) address and a UL tunnel endpoint identifier (TEID). The DL packet transmission end point may be a DL TNL address and a DL TEID. The DL TNL address and the DL TEID may be generated at any node in the RAN. The UL TNL address and the UL TEID may be generated in the CN. Here, the RAN-CN control interface may exist between RAN MN and the CN. Accordingly, the MN can obtain an SN DL TEID and an SN DL TNL address terminated in the SN in advance through the RAN-RAN control interface.

In more detail, in the NR, several protocol data unit (PDU) sessions may exist for the terminal. The PDU session may be identified by a PDU session ID. One PDU session may include several QoS flows. Several QoS flows may be identified by QoS flow IDs. Accordingly, the TNL address and TEID may be allocated for each QoS flow. Several QoS flows may have one TNL address and TEID. Several QoS flows may be included in one TEID and transmitted.

Meanwhile, in the RAN-RAN control interface, an MN node of the RAN initially may include a unique M-NG-RAN node UE XnAP ID (in other words, CP-Y-1) for the corresponding terminal in message 3 and transmit the message 3 to a RAN SN node. Then, the RAN SN node may generate a unique S-NG-RAN node UE XnAP ID for the corresponding terminal, and include information (in other words, CP-Y-2) including the M-NG-RAN node UE XnAP ID received from the RAN MN node and the S-NG-RAN node UE issued by the RAN SN node in message 3A, and transmit the message 3A to the MN.

Thereafter, the RAN-RAN control interface message for the corresponding terminal may include the M-NG-RAN node UE XnAP ID and the S-NG-RAN node UE XnAP ID. As a result, it can be seen that a message including CP-Y2 exchanged between the RAN MN and RAN is the RAN-RAN control interface message for the corresponding terminal.

In the RAN-RAN control interface, the MN and the SN may exchange message 4 and message 4A. This exchange means the case where the MN PDCPs connected to the MCG/SCG/split bearers in the RAN MN node are in the MN (in other words, when the QoS flows related to the MCG/SCG/split bearers go to the MN (in other words, when the MN is terminated)), and may be for UL/DL UP path configuration between the MN PDCP and the SN RLC.

Message 5 and message 5A may be exchanged in the RAN-RAN control interface. This exchange means the case where the SN PDCPs connected to the MCG/SCG/split bearers in the RAN SN node of FIG. 7 are in the SN (in other words, when the QoS flows related to the MCG/SCG/split bearers go to the SN (in other words, when the SN is terminated)), and may be for UL/DL UP path configuration between the SN PDCP and the MN RLC.

In the message 4/4A and message 5/5A exchange, MCG RLS of the 3GPP standard may only exist in the MN, and SCG RLC may necessarily only exist in the SN. In this regard, in the present disclosure, MCG RLS of the MN can be mirrored to the MCG RLS of the SN to be configured as a new instance. In addition, the SCG RLS of the SN can also be mirrored to the SCG RLS of the MN to be configured as a new instance. Through this difference, the switching from the MN to the SN is possible.

The message 4 and the message 4A may be exchanged in the RAN-RAN control interface. In this exchange, when all the PDCPs associated with the MCG/SCG/split bearers may exist in the MN, and the QoS flows related to the MCG/SCG/split bearers may be transmitted and received in the MN (MN termination). Here, the RAN MN and the RAN SN may know both the DL packet transmission end point from RAN MN PDCP to RAN SN RLC and the UL packet transmission end point from RAN SN RLC to RAN MN PDCP through the exchange of the message 4 and message 4A. Here, an SN-IN TNL address and an SN-IN TEID from the MN to the SN may be generated by the SN node of the RAN. An MN-IN TNL address and an MN-IN TEID from the SN to the MN may be generated by the RAN MN. In the UP path configuration, several PDU sessions such as UP B-1 or UP B-2 information may exist in one UE. The sessions may be identified by the PDU session ID. There may be several PDU sessions. One PDU session may include several DRB IDs. One DRB may have one TNL address and TEID. One DRB may be mapped to one or more QoS flows. Several QoS flows may be included in the same TEID.

The message 5 and the message 5A may be exchanged in the RAN-RAN control interface. In this exchange, when all the PDCPs related to the MCG/SCG/split bearers may exist in the SN, and the QoS flows related to the MCG/SCG/split bearers may be transmitted and received in the SN (SN termination).

Here, the RAN MN and the RAN SN may know both the DL packet transmission end point from RAN SN PDCP to RAN MN RLC and the UL packet transmission end point from RAN MN RLC to RAN SN PDCP through the exchange of the message 5 and message 5A. Here, the SN-IN TNL address and the SN-IN TEID from the MN to the SN may be generated at the SN node of the RAN, and the MN-IN TNL address and the MN-IN TEID from the SN to the MN may be generated at the RAN MN node.

In the UP path configuration, several PDU sessions may exist in one terminal in the UP C-1 or UP C-2 information. The sessions may be identified by the PDU session ID. One PDU session may include several DRB IDs. One DRB may have one TNL address and TEID. One DRB may be mapped to one or more QoS flows. Several QoS flows may be included in the same TEID.

The description with reference to FIG. 7 is that, in an RAN-CP control interface, the CP information and the UP information may be separated into CP X-1 and CP X-2, and UP A-1 and UP A-2 to be included in the message 1 and the message IA and the message 2 and message 2A. Most of the CP X-2 may be included in any message that may also include the UP A-1 or the UP A-2 for the UP configuration as well as various types of control information. For the initial CP connection, any message may or may not include not only UP-A information for the UP configuration, but also various types of other control information while including only the AMF UE NGAP ID of the CP.

The description with reference to FIG. 7 is that, in an RAN-CP control interface, the CP information and the UP information may be separated into CP Y-1 and CP Y-2 and UP B-1, UP B-2, UP C-1, and UP C-2 to be included in the messages 3/3A, 4/4A, and 5/5A. However, most of the CP Y-2 may be included in any message. The UP B-1/UP B-2 or the UP C-1/UP C-2 as well as various types of control information may be included in any message for the UP configuration. For the initial CP connection, the CP Y-1 of any message may include not only UP-B or UP-C information for the UP configuration, but also various types of other control information while including only the S-NG-RAN node UE XnAP ID of the CP Y-2.

Any MCG PDCP may be instanced into the MN PDCP in the MN and MN-terminated, and any other MCG PDCPs may be instanced into the SN PDCP in the SN and SN-terminated. Any SCG PDCP may be instanced into the MN PDCP in the SN and may be MN-terminated, and any other SCG PDCPs may be instanced into the SN PDCP in the SN and SN-terminated. Any split PDCP may be instanced into the MN PDCP in the SN and MN-terminated, and any other split PDCPs may be instanced into the SN PDCP in the SN and SN-terminated. In the 3GPP standard, the MCG RLS may only be instanced into the MN RLC, the SCG RLC may only be instanced into the SN RLC, and the split RLC may be instanced into the MN RLC and the SN RLC in both the MN and the SN. Next, the present disclosure may describe the UP configuration configured between the RAN-CNs as illustrated in FIG. 7 using the RAN-CN control interface messages of FIG. 8 on the MN-CN control interface of the RAN of FIG. 6.

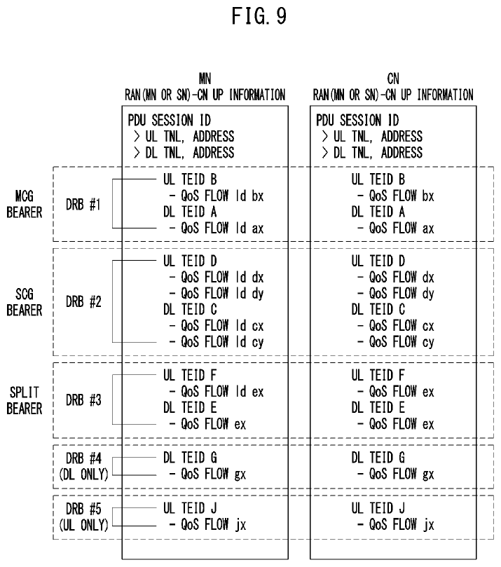

FIG. 9 is a conceptual diagram illustrating a first embodiment of the UP information.

Referring to FIG. 9, DRB #1 may be assumed to be the MCG bearer, DRB #2 may be assumed to be the SCG bearer, DRB #3 may be assumed to be the split bearer, DRB #4 may be assumed to be a DL only bearer, and DRB #5 may be assumed to be a UL only bearer. For the MCG/SCG/split bearers, it can be seen how the MN (or SN) and CN store UP-related information in the RAN node (MN or SN) and CN. The DRB #1 is the MCG bearer, and may have the UL TEID and the DL TEID for each UL and DL and have one QoS flow per TEID. The DRB #2 is the SCG bearer, and may have the UL TEID and the DL TEID for each UL and DL and have two QoS flows per TEID.

The DRB #3 is the split bearer, and may have the UL TEID and the DL TEID for each of the UL and DL and may be associated with two QoS flows per TEID. The DRB #4 may assume one DL TEID and one DL QoS flow mapping per TEID. The DRB #5 may assume one UL TEID and one UL QoS flow mapping per TEID. The DL TNL addresses and the DL TEID of the DRB #1, #2, #3, and #4 may be generated in the MN (in other words, MN termination) or in the SN. The UL TNL addresses and the UL TEID of the DRB #1, #2, #3, and #5 may be generated in the CN. This information may have the UP information for each PDU session, and this information may be shared by the RAN node (MN or SN) and the CN.

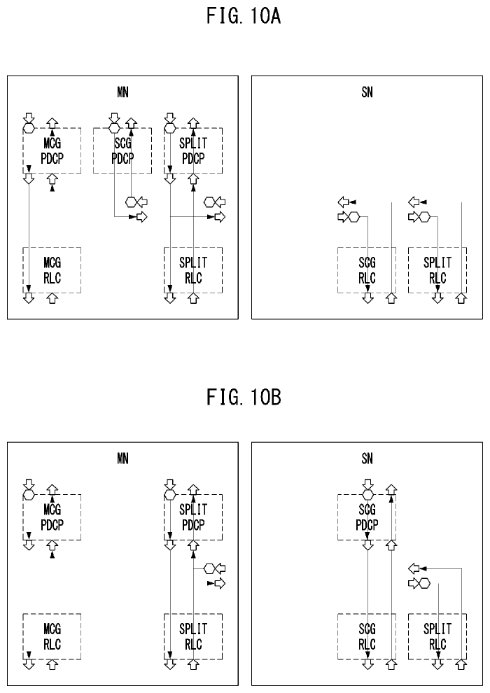

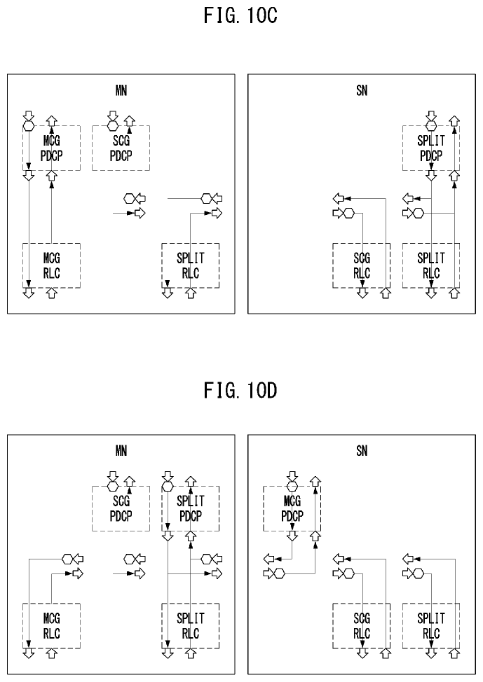

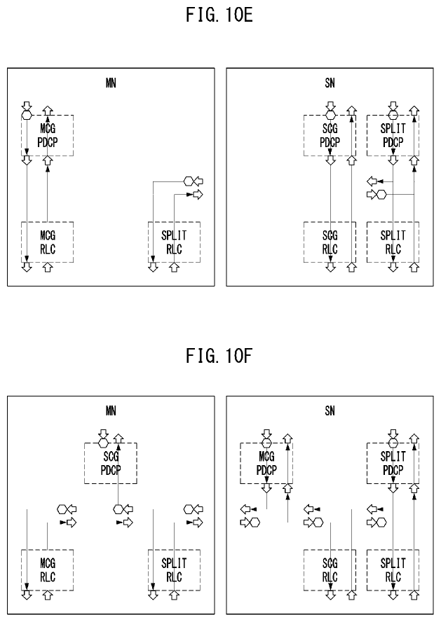

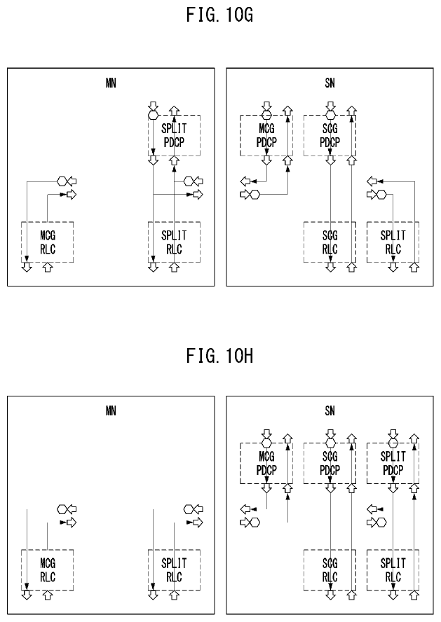

FIG. 10A is a conceptual diagram illustrating a first embodiment of UP paths between the MN and the CN and the MN and the SN.

Referring to FIG. 10A, the MN may include the MCG PDCP, the SCG PDCP, the split PDCP, the MCG RLS, and the split RLC. The SN may include the SCG RLC and the split RLC. The MCG/SCG/split PDCP may be MN-terminated. The MN and CN of the RAN may have an UP path. In addition, the MN of the RAN and the SN of the RAN may have an UP path. The UP path between the RAN-CN may be indicated by a UL arrow, a DL arrow, and a hexagonal TNL addresses. In this case, the UP path between the RAN-CN may include the DL UP path and the UL UP path. The UP path between the MN of the RAN and the SN of the RAN may be indicated by a right arrow, a left arrow, and a hexagonal TNL address. In this case, the UP path between the MN of the RAN and the SN of the RAN may include the DL UP path and the UL UP path. Meanwhile, the SCG PDCP and the SCG RLC may have an Xn-U UL/DL UP path. In addition, the split PDCP and the split RLC may have the Xn-U UL/DL UP path. Here, the term “terminated” may mean that a bearer has an UP path with a corresponding RAN node in the UP path information with the RAN-CN.

FIG. 10B is a conceptual diagram illustrating a second embodiment of UP paths between the MN and the CN and the MN and the SN.

Referring to FIG. 10B, the MN may include the MCG PDCP, the split PDCP, the MCG RLS, and the split RLC. The SN may include the SCG PDCP, the SCG RLC, and the split RLC. The MCG/split PDCP may be MN-terminated, and the SCG PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the MN and the split RLC of the SN may have the Xn-U UL/DL UP path. Here, the term “terminated” may mean that a bearer has an UP path with a corresponding RAN node in the UP path information with the RAN-CN.

FIG. 10C is a conceptual diagram illustrating a third embodiment of UP paths between the MN and the CN and the MN and the SN.

Referring to FIG. 10C, the MN may include the MCG PDCP, the SCG PDCP, the MCG RLS, and the split RLC. The SN may include the split PDCP, the SCG RLC, and the split RLC. The MCG/SCG PDCP may be MN-terminated, and the split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the split PDCP of the SN and the split RLC of the MN may have the Xn-U UL/DL UP path. Here, the term “terminated” may mean that a bearer has an UP path with a corresponding RAN node in the UP path information with the RAN-CN.

FIG. 10D is a conceptual diagram illustrating a fourth embodiment of UP paths between the MN and the CN and the MN and the SN.

Referring to FIG. 10D, the MN may include the SCG PDCP, the split PDCP, the MCG RLS, and the split RLC. The SN may include the MCG PDCP, the SCG RLC, and the split RLC. The SCG/split PDCP may be MN-terminated, and the MCG PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the MCG PDCP of the SN and the MCG RLC of the MN may have the Xn-U UL/DL UP path. Here, the term “terminated” may mean that a bearer has an UP path with a corresponding RAN node in the UP path information with the RAN-CN.

FIG. 10E is a conceptual diagram illustrating a fifth embodiment of UP paths between the MN and the CN and the MN and the SN.

Referring to FIG. 10E, the MN may include the MCG PDCP, the MCG RLS, and the split RLC. The SN may include the SCG PDCP, the split PDCP, the SCG RLC, and the split RLC. The MCG PDCP may be MN-terminated, and the SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the SN and the split RLC of the MN may have the Xn-U UL/DL UP path. Here, the term “terminated” may mean that a bearer has an UP path with a corresponding RAN node in the UP path information with the RAN-CN.

FIG. 10F is a conceptual diagram illustrating a sixth embodiment of UP paths between the MN and the CN and the MN and the SN.

Referring to FIG. 10F, the MN may include the SCG PDCP, the MCG RLS, and the split RLC. The SN may include the MCG PDCP, the split PDCP, the SCG RLC, and the split RLC. The SCG PDCP may be MN-terminated, and the MCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the MCG PDCP of the SN and the MCG RLC of the MN may have the Xn-U UL/DL UP path. In addition, the split PDCP of the SN and the split RLC of the MN may have the Xn-U UL/DL UP path. Here, the term “terminated” may mean that a bearer has an UP path with a corresponding RAN node in the UP path information with the RAN-CN.

FIG. 10G is a conceptual diagram illustrating a seventh embodiment of UP paths between the MN and the CN and the MN and the SN.

Referring to FIG. 10G, the MN may include the split PDCP, the MCG RLS, and the split RLC. The SN may include the MCG PDCP, the SCG PDCP, the SCG RLC, and the split RLC. The split PDCP may be MN-terminated, and the MCG/SCG PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the MN and the split RLC of the SN may have the Xn-U UL/DL UP path. In addition, the MCG PDCP of the SN and the MCG RLC of the MN may have the Xn-U UL/DL UP path. In addition, the SCG PDCP of the SN and the SCG RLC of the MN may have the Xn-U UL/DL UP path. Here, the term “terminated” may mean that a bearer has an UP path with a corresponding RAN node in the UP path information with the RAN-CN.

FIG. 10H is a conceptual diagram illustrating an eighth embodiment of UP paths between the MN and the CN and the MN and the SN.

Referring to FIG. 10H, the MN may include the MCG PDCP and the split RLC. The SN may include the MCG PDCP, the SCG PDCP, the split PDCP, the SCG RLC, and the split RLC. The MCG/SCG/split PDCP may be SN-terminated. The SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the MCG PDCP and the MCG RLC may have the Xn-U UL/DL UP path. In addition, the split PDCP and the split RLC may have the Xn-U UL/DL UP path. Here, the term “terminated” may mean that a bearer has an UP path with a corresponding RAN node in the UP path information with the RAN-CN. Next, the present disclosure may describe how the information on the UP path between the RAN MN and the RAN SN for the MCG/SCG/split bearer configured through the message exchange (in other words, information elements of UP B-1/B-2, C-1/C-2) of FIG. 8 on the RAN-RAN control interface in FIG. 6 based on FIGS. 10A and 10F is managed.

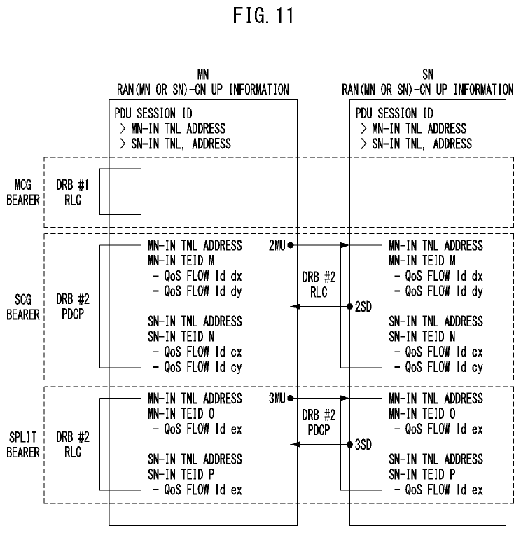

FIG. 11 is a conceptual diagram illustrating a first embodiment of the information exchange for connection between the MN and the SN.

Referring to FIG. 11, MCG bearer-related information may not exist. This may be because there is no UP path configuration of the MCG bearer between the RAN MN and RAN SN. The UP information of the SCG bearer between the RAN MN and the RAN SN may be required for connection with the MN SCG PDCP and the SN SCG RLC. To this end, the MN may generate 2MU information and transmit the generated 2MU information to the SN. Here, the 2MU information may include the MN-IN TNL, the MN-IN-TEID, the QoS flow ID, etc., of the SCG bearer. Through this process, the RAN MN-RAN SN connection to the SCG bearer may be made. The SN may generate 2SD and transmit the generated 2SD to the MN. Here, the 2SD information may include the SN-IN TNL, the SN-IN-TEID, the QoS flow ID, etc., of the SCG bearer. In addition, the UP information between the RAN MN and the RAN SN may be required for connection with MN split PDCP and SN split RLC. To this end, the MN may generate 3MU information and transmit the generated 3MU information to the SN. Here, the 3MU information may include the MN-IN TNL, the MN-IN-TEID, the QoS flow ID, etc., of the split bearer. The SN may generate 3SD and transmit the generated 3SD to the MN. Here, the 3SD information may include the SN-IN TNL, the SN-IN-TEID, the QoS flow ID, etc., of the split bearer. Through this process, the RAN MN-RAN SN connection to the split bearer may be made.

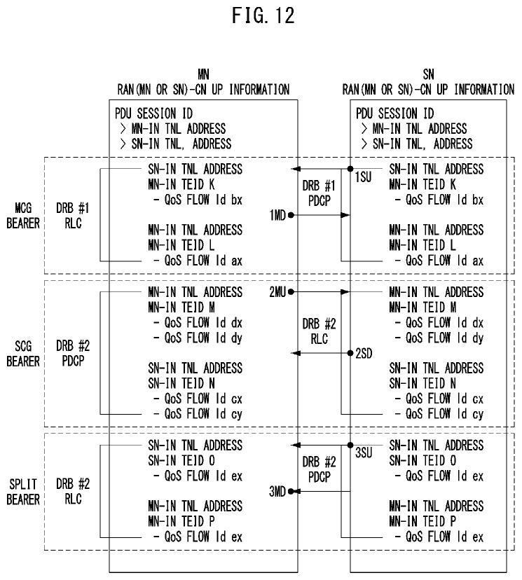

FIG. 12 is a conceptual diagram illustrating a second embodiment of the information exchange for connection between the MN and the SN.

Referring to FIG. 12, the UP information of the MCG bearer between the RAN MN and the RAN SN may be required for connection between SN MCG PDCP and MN MCG RLS. To this end, the SN may generate 1SU information and transmit the generated 1SU information to the MN. Here, the 1SU information may include the SN-IN TNL, the SN-IN-TEID, the QoS flow ID, etc., of the MCG bearer. In addition, the MN may generate 1MD information and transmit the generated 1MD information to the SN. Here, the 1MD information may include the MN-IN TNL, the MN-IN-TEID, the QoS flow ID, etc., of the MCG bearer. Through this process, the RAN MN-RAN SN connection to the MCG bearer may be made. In addition, the UP information between the RAN MN and the RAN SN may be required for connection with the MN SCG PDCP and SN SCG RLC. To this end, the MN may generate 2MU information and transmit the generated 2MU information to the SN. Here, the 2MU information may include the MN-IN TNL, the MN-IN-TEID, the QoS flow ID, etc., of the SCG bearer. Through this process, the RAN MN-RAN SN connection to the SCG bearer may be made. The SN may generate 2SD and transmit the generated 2SD to the MN. Here, the 2SD information may include the SN-IN TNL, the SN-IN-TEID, the QoS flow ID, etc., of the SCG bearer. In addition, the UP information between the RAN MN and the RAN SN may be required for connection with SN split PDCP and SN split PLC. To this end, the SN may generate 3SU information and transmit the generated 3SU information to the MN. Here, the 3SU information may include the SN-IN TNL, the SN-IN-TEID, the QoS flow ID, etc., of the SCG bearer. The MN may generate 3MD and transmit the generated 3MD to the SN. Here, the 3MD information may include the MN-IN TNL, the MN-IN-TEID, the QoS flow ID, etc., of the MCG bearer. Through this process, the RAN MN-RAN SN connection to the split bearer may be made.

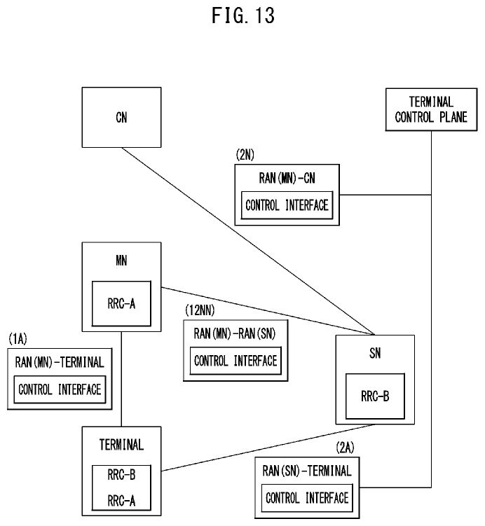

FIG. 13 is a conceptual diagram illustrating a first embodiment of a change in the control interface for switching from the MN to the SN.

Referring to FIG. 13, for the SDS from the MN to the SN, the MN-CN control interface of the RAN may be changed to the SN-CN control interface of RAN. In other words, the existing radio interfaces 1A and 2A may be recycled, and the RAN-RAN control interface (12NN) may also be recycled. However, the MN-CN control interface of the RAN can be changed to the SN-CN control interface of the RAN (2N).

This may mean that the role of the existing MN is changed to the SN and the role of the existing SN is changed to the MN. However, to avoid a technical confusion, the MN may continue to be written as MN, and the SN may continue to be written as SN. When looking at an internal control field for the SN-CN control interface of the RAN, the AMF UE NGAP ID may remain the same. The RAN UE NGAP ID generated by the MN may be changed to the RAN UE NGAP ID generated by the SN. This change is possible by the messages defined for the SDS from the MN to the SN, which will be described below.

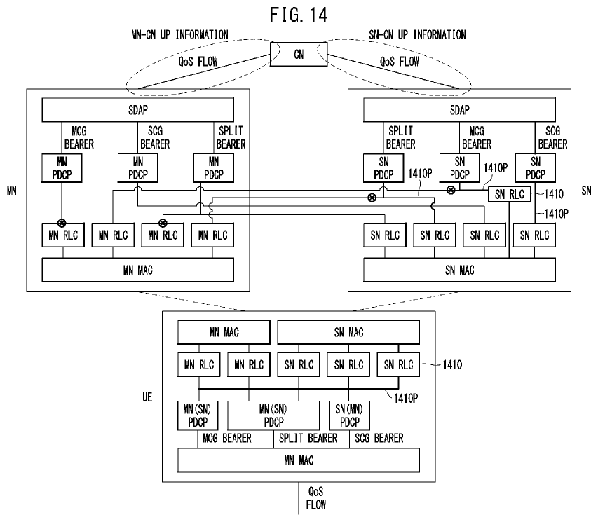

FIG. 14 is a conceptual diagram illustrating a second embodiment of the UP in the single control plane operation method.

Referring to FIG. 14, the UP may include new SN RLCs 1410 and new UP paths 1410P. ⊗ means blocking the packet transmission, and DL packets may be blocked from the MN PDCP of the MCG bearer of the MN to the MN RLC. In addition, the DL packets may be blocked from the MN PDCP of the split bearer of the MN to the MN RLC. In addition, the DL packets may be blocked from the SN PDCP of the MCG bearer of the SN to the MN RLC. In addition, the DL packets may be blocked from the SN PDCP of the split bearer of the SN to the MN RLC. In this process, a new SN RLC instance may be required in the SN. Although not indicated, the terminal may block transmission of UL packets from the PDCP to the MN RLC at appropriate times.

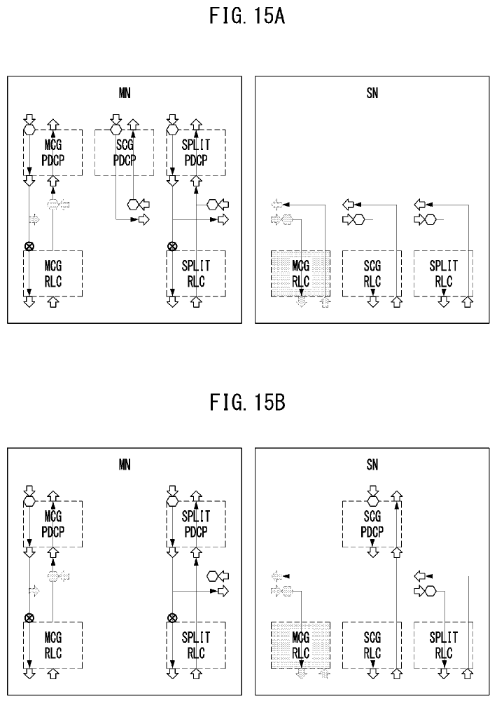

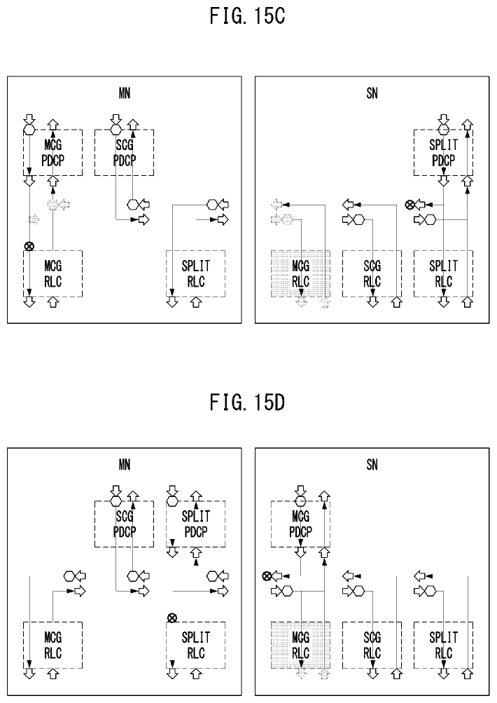

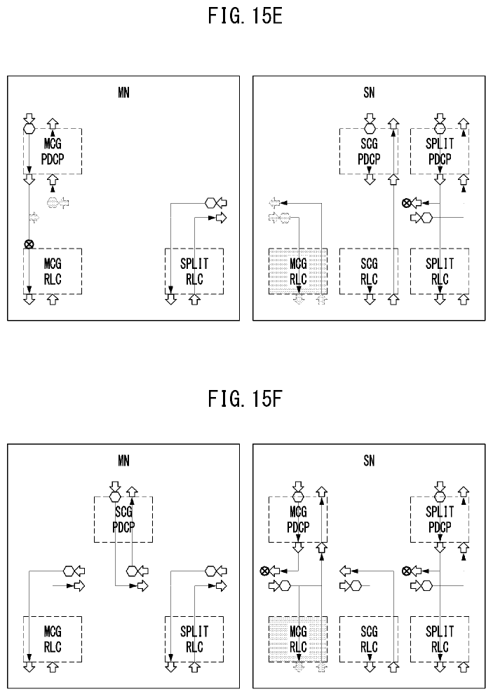

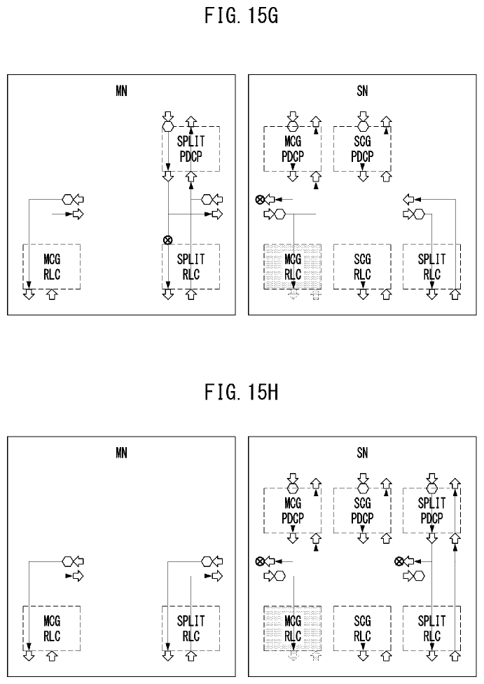

FIG. 15A is a conceptual diagram illustrating a first embodiment of UP paths between the MN and the CN and the MN and the SN for switching.

Referring to FIG. 15A, the MN may include the MCG PDCP, the SCG PDCP, the split PDCP, the MCG RLS, and the split RLC. The SN may include the MCG PDCP, the SCG RLC, and the split RLC. The MCG/SCG/split PDCP may be MN-terminated. The MN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP and the SCG RLC may have the Xn-U UL/DL UP path. In addition, the split PDCP and the split RLC may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the MN to the split RLC of the MN may be blocked, and only the path from the split PDCP of the MN to the split RLC of the SN may be used. In this case, the UL path may be directed from the split RLC of the SN to the split PDCP of the MN.

FIG. 15B is a conceptual diagram illustrating a second embodiment of UP paths between the MN and the CN and the MN and the SN for switching.

Referring to FIG. 15B, the MN may include the MCG PDCP, the split PDCP, the MCG RLS, and the split RLC. The SN may include the SCG PDCP, the MCG RLS, the SCG RLC, and the split RLC. The MCG/split PDCP may be MN-terminated, and the SCG PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the MN and the split RLC of the SN may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the MN to the split RLC of the MN may be blocked, and only the path from the split PDCP of the MN to the split RLC of the SN may be used. In this case, the UL path may be directed from the split RLC of the SN to the split PDCP of the MN.

FIG. 15C is a conceptual diagram illustrating a third embodiment of UP paths between the MN and the CN and the MN and the SN for switching.

Referring to FIG. 15C, the MN may include the MCG PDCP, the SCG PDCP, the MCG RLS, and the split RLC. The SN may include the split PDCP, the MCG RLS, the SCG RLC, and the split RLC. The MCG/SCG PDCP may be MN-terminated, and the split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the split PDCP of the SN and the split RLC of the MN may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the SN to the split RLC of the SN may be blocked, and only the path from the split PDCP of the MN to the split RLC of the SN may be used. In this case, the UL path may be directed from the split RLC of the SN to the split PDCP of the SN.

FIG. 15D is a conceptual diagram illustrating a fourth embodiment of UP paths between the MN and the CN and the MN and the SN for switching.

Referring to FIG. 15D, the MN may include the SCG PDCP, the split PDCP, the MCG RLS, and the split RLC. The SN may include the MCG PDCP, the MCG RLS, the SCG RLC, and the split RLC. The SCG/split PDCP may be MN-terminated, and the MCG PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the MCG PDCP of the SN and the MCG RLC of the MN may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the split PDCP of the SN to the split RLC of the MN may be blocked. In addition, the DL path from the MCG PDCP of the SN to the MCG RLS of the MN may be blocked.

FIG. 15E is a conceptual diagram illustrating a fifth embodiment of UP paths between the MN and the CN and the MN and the SN for switching.

Referring to FIG. 15E, the MN may include the MCG PDCP, the MCG RLS, and the split RLC. The SN may include the SCG PDCP, the split PDCP, the MCG RLS, the SCG RLC, and the split RLC. The MCG PDCP may be MN-terminated, and the SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the SN and the split RLC of the MN may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the MN to the split RLC of the MN may be blocked, and only the path from the split PDCP of the MN to the split RLC of the SN may be used. In this case, the UL path may be directed from the split RLC of the SN to the split PDCP of the MN.

FIG. 15F is a conceptual diagram illustrating a sixth embodiment of UP paths between the MN and the CN and the MN and the SN for switching.

Referring to FIG. 15F, the MN may include the SCG PDCP, the MCG RLS, and the split RLC. The SN may include the MCG PDCP, the split PDCP, the SCG RLC, and the split RLC. The SCG PDCP may be MN-terminated, and the MCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the MCG PDCP of the SN and the MCG RLC of the MN may have the Xn-U UL/DL UP path. In addition, the split PDCP of the SN and the split RLC of the MN may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the split PDCP of the SN to the split RLC of the MN may be blocked. In addition, the DL path from the MCG PDCP of the SN to the MCG RLS of the MN may be blocked.

FIG. 15G is a conceptual diagram illustrating a seventh embodiment of UP paths between the MN and the CN and the MN and the SN for switching.

Referring to FIG. 15G, the MN may include the split PDCP, the MCG RLS, and the split RLC. The SN may include the MCG PDCP, the SCG PDCP, the MCG RLS, the SCG RLC, and the split RLC. The split PDCP may be MN-terminated, and the MCG/SCG PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the MN and the split RLC of the SN may have the Xn-U UL/DL UP path. In addition, the MCG PDCP of the SN and the MCG RLC of the MN may have the Xn-U UL/DL UP path. In addition, the SCG PDCP of the SN and the SCG RLC of the MN may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the split PDCP of the MN to the split RLC of the MN may be blocked. In addition, the DL path from the MCG PDCP of the SN to the MCG RLS of the MN may be blocked.

FIG. 15H is a conceptual diagram illustrating an eighth embodiment of UP paths between the MN and the CN and the MN and the SN for switching.

Referring to FIG. 15H, the MN may include the MCG PDCP and the split RLC. The SN may include the MCG PDCP, the SCG PDCP, the split PDCP, the MCG RLS, the SCG RLC, and the split RLC. The MCG/SCG/split PDCP may be SN-terminated. The SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the MCG PDCP and the MCG RLC may have the Xn-U UL/DL UP path. In addition, the split PDCP and the split RLC may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the split PDCP of the SN to the split RLC of the MN may be blocked. In addition, the DL path from the MCG PDCP of the SN to the MCG RLS of the MN may be blocked.

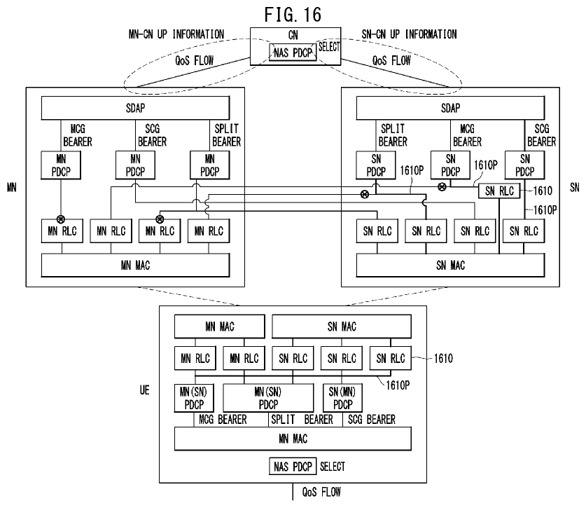

FIG. 16 is a conceptual diagram illustrating a third embodiment of the UP in the single control plane operation method.

Referring to FIG. 16, the UP may include new SN RLCs 1610 and new UP paths 1610P. ⊗ means blocking the packet transmission, and DL packets may be blocked from the MN PDCP of the MCG bearer of the MN to the MN RLC. In addition, the DL packets may be blocked from the MN PDCP of the split bearer of the MN to the MN RLC. In addition, the DL packets may be blocked from the SN PDCP of the MCG bearer of the SN to the MN RLC. In addition, the DL packets may be blocked from the SN PDCP of the split bearer of the SN to the MN RLC. In this process, a new SN RLC instance may be required in the SN. Although not indicated, the terminal may block transmission of UL packets from the PDCP to the MN RLC at appropriate times. In addition, the CN may include a non-access stratum (NAS) PDCP and may include the NAS PDCP as the terminal.

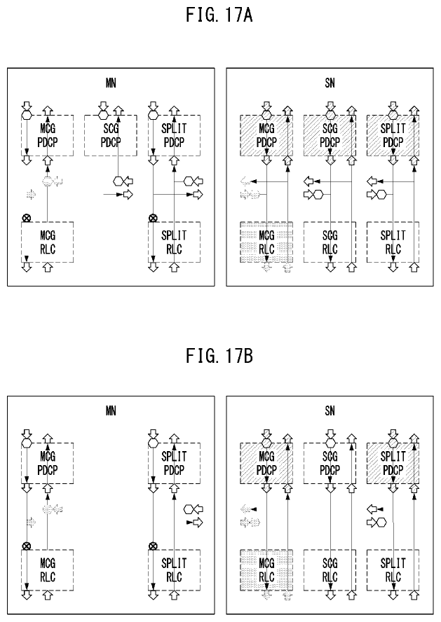

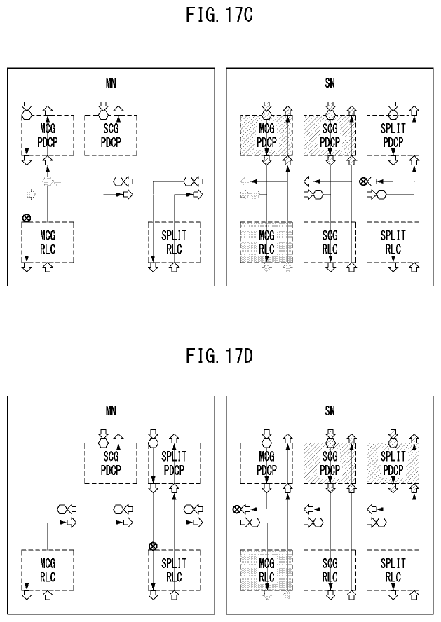

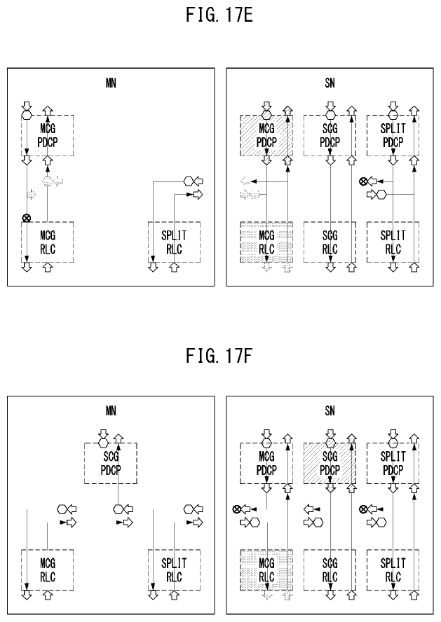

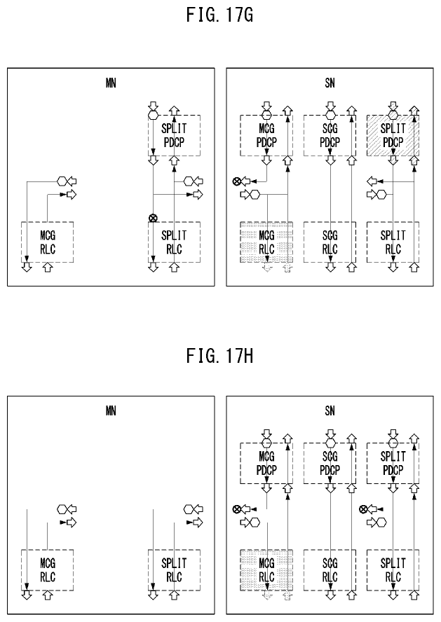

FIG. 17A is a conceptual diagram illustrating a first embodiment of additional paths of the UP between the MN and the CN and the MN and the SN for switching.

Referring to FIG. 17A, the MN may include the MCG PDCP, the SCG PDCP, the split PDCP, the MCG RLS, and the split RLC. The SN may include the MCG PDCP, the SCG PDCP, the split PDCP, the MCG RLS, the SCG RLC, and the split RLC. The MCG/SCG/split PDCP may be MN-terminated. In addition, the MCG/SCG/split PDCP may be SN-terminated. The MN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP and the SCG RLC may have the Xn-U UL/DL UP path. In addition, the split PDCP and the split RLC may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the MN to the split RLC of the MN may be blocked, and only the path from the split PDCP of the MN to the split RLC of the SN may be used. In this case, the UL path may be directed from the split RLC of the SN to the split PDCP of the MN.

FIG. 17B is a conceptual diagram illustrating a second embodiment of additional paths of the UP between the MN and the CN and the MN and the SN for switching.

Referring to FIG. 17B, the MN may include the MCG PDCP, the split PDCP, the MCG RLS, and the split RLC. The SN may include the MCG PDCP, the SCG PDCP, the split PDCP, the MCG RLS, the SCG RLC, and the split RLC. The MCG/split PDCP may be MN-terminated, and the MCG/SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated using the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the MN and the split RLC of the SN may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the MN to the split RLC of the MN may be blocked, and only the path from the split PDCP of the MN to the split RLC of the SN may be used. In this case, the UL path may be directed from the split RLC of the SN to the split PDCP of the MN.

FIG. 17C is a conceptual diagram illustrating a third embodiment of additional paths of the UP between the MN and the CN and the MN and the SN for switching.

Referring to FIG. 17C, the MN may include the MCG PDCP, the SCG PDCP, the MCG RLS, and the split RLC. The SN may include the MCG PDCP, the SCG PDCP, the split PDCP, the MCG RLS, the SCG RLC, and the split RLC. The MCG/split PDCP may be MN-terminated, and the MCG/SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the split PDCP of the SN and the split RLC of the MN may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the SN to the split RLC of the SN may be blocked, and only the path from the split PDCP of the MN to the split RLC of the SN may be used. In this case, the UL path may be directed from the split RLC of the SN to the split PDCP of the SN.

FIG. 17D is a conceptual diagram illustrating a fourth embodiment of additional paths of the UP between the MN and the CN and the MN and the SN for switching.

Referring to FIG. 17D, the MN may include the SCG PDCP, the split PDCP, the MCG RLS, and the split RLC. The SN may include the MCG PDCP, the SCG PDCP, the split PDCP, the MCG RLS, the SCG RLC, and the split RLC. The SCG/split PDCP may be MN-terminated, and the MCG/SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the MCG PDCP of the SN and the MCG RLC of the MN may have the Xn-U UL/DL UP path. Here, the term “terminated” may mean that a bearer has an UP path with a corresponding RAN node in the UP path information with the RAN-CN.

In this situation, ⊗ means blocking the packet transmission, and the DL path from the split PDCP of the SN to the split RLC of the MN may be blocked. In addition, the DL path from the MCG PDCP of the SN to the MCG RLS of the MN may be blocked.

FIG. 17E is a conceptual diagram illustrating a fifth embodiment of additional paths of the UP between the MN and the CN and the MN and the SN for switching.

Referring to FIG. 15E, the MN may include the MCG PDCP, the MCG RLS, and the split RLC. The SN may include the MCG PDCP, the SCG PDCP, the split PDCP, the MCG RLS, the SCG RLC, and the split RLC. The MCG PDCP may be MN-terminated, and the MCG/SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the SN and the split RLC of the MN may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the MCG PDCP of the MN to the MCG RLS of the MN may be blocked, and the path from the MCG PDCP of the MN to the MCG RLS of the SN may be generated. In this case, the UL path may be directed from the MCG RLS of the SN to the MCG PDCP of the MN. In addition, the DL path from the split PDCP of the MN to the split RLC of the MN may be blocked, and only the path from the split PDCP of the MN to the split RLC of the SN may be used. In this case, the UL path may be directed from the split RLC of the SN to the split PDCP of the MN.

FIG. 17F is a conceptual diagram illustrating a sixth embodiment of additional paths of the UP between the MN and the CN and the MN and the SN for switching.

Referring to FIG. 17F, the MN may include the SCG PDCP, the MCG RLS, and the split RLC. The SN may include the MCG PDCP, the SCG PDCP, the split PDCP, the SCG RLC, and the split RLC. The SCG PDCP may be MN-terminated, and the MCG/SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the SCG PDCP of the MN and the SCG RLC of the SN may have the Xn-U UL/DL UP path. In addition, the MCG PDCP of the SN and the MCG RLC of the MN may have the Xn-U UL/DL UP path. In addition, the split PDCP of the SN and the split RLC of the MN may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the split PDCP of the SN to the split RLC of the MN may be blocked. In addition, the DL path from the MCG PDCP of the SN to the MCG RLS of the MN may be blocked.

FIG. 17G is a conceptual diagram illustrating a seventh embodiment of UP paths between the MN and the CN and the MN and the SN for switching.

Referring to FIG. 17G, the MN may include the split PDCP, the MCG RLS, and the split RLC. The SN may include the MCG PDCP, the SCG PDCP, the split PDCP, the MCG RLS, the SCG RLC, and the split RLC. The split PDCP may be MN-terminated, and the MCG/SCG/split PDCP may be SN-terminated. The MN and CN of the RAN may have an UP path. In addition, the SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the split PDCP of the MN and the split RLC of the SN may have the Xn-U UL/DL UP path. In addition, the MCG PDCP of the SN and the MCG RLC of the MN may have the Xn-U UL/DL UP path. In addition, the SCG PDCP of the SN and the SCG RLC of the MN may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the split PDCP of the MN to the split RLC of the MN may be blocked. In addition, the DL path from the MCG PDCP of the SN to the MCG RLS of the MN may be blocked.

FIG. 17H is a conceptual diagram illustrating an eighth embodiment of additional paths of the UP between the MN and the CN and the MN and the SN for switching.

Referring to FIG. 17H, the MN may include the MCG PDCP and the split RLC. The SN may include the MCG PDCP, the SCG PDCP, the split PDCP, the MCG RLS, the SCG RLC, and the split RLC. The MCG/SCG/split PDCP may be SN-terminated. The SN and CN of the RAN may have an UP path. In addition, the MN of the RAN and the SN of the RAN may have an UP path. The UP path between the RAN-CN may be indicated by the UL arrow, the DL arrow, and the hexagonal TNL addresses. In this case, the UP path between the RAN-CN may include the DL UP path and the UL UP path. The UP path between the MN of the RAN and the SN of the RAN may be indicated by the right arrow, the left arrow, and the hexagonal TNL address. In this case, the UP path between the MN of the RAN and the SN of the RAN may include the DL UP path and the UL UP path. Meanwhile, the MCG PDCP and the MCG RLC may have the Xn-U UL/DL UP path. In addition, the split PDCP and the split RLC may have the Xn-U UL/DL UP path. Here, the term “terminated” may mean that a bearer has an UP path with a corresponding RAN node in the UP path information with the RAN-CN. In this situation, ⊗ means blocking the packet transmission, and the DL path from the split PDCP of the SN to the split RLC of the MN may be blocked. In addition, the DL path from the MCG PDCP of the SN to the MCG RLS of the MN may be blocked.

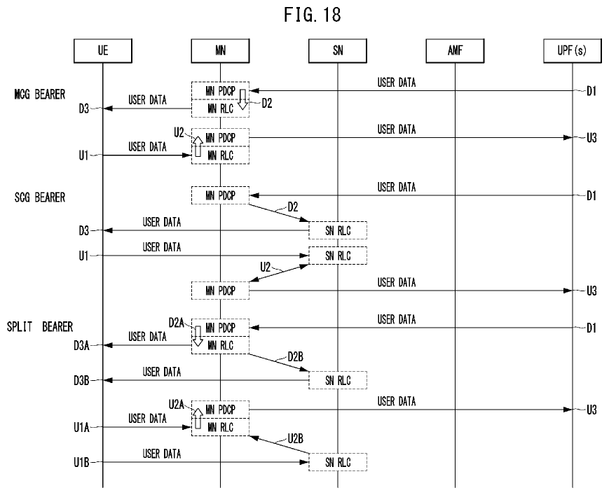

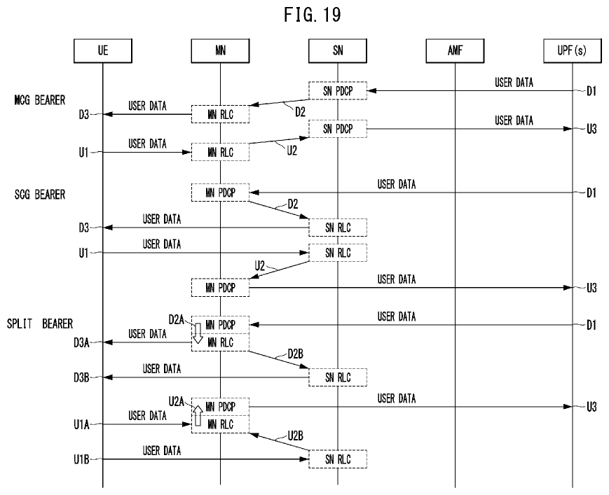

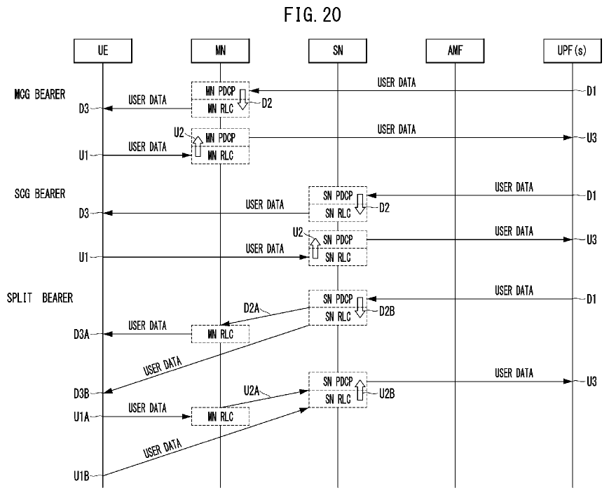

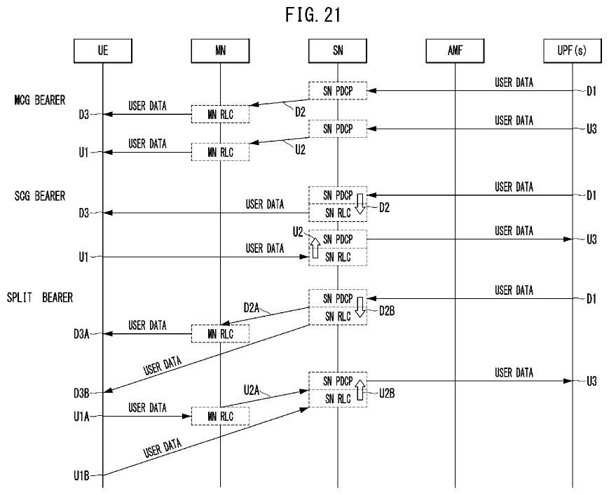

FIG. 18 is a flowchart illustrating a first embodiment of a processing of transmitting user data.

Referring to FIG. 18, a user plane function (UPF) in the MCG bearer may transmit user data of the DL to the MN PDCP of the MN (D1). Then, the MN PDCP may receive the user data from the UPF and transmit the received user data to the MN RLC (D2). Accordingly, the MN RLC may transmit the user data to the terminal (D3). The terminal may receive the user data from the MN RLC.

Meanwhile, in the MCG bearer, the terminal may transmit user data of the UL to the MN RLC (U1). Then, the MN RLC may receive the user data from the terminal. The MN RLC may transmit the user data to the MN PDCP (U2). Accordingly, the MN PDCP may transmit the user data to the UPF (U3). Then, the UPF may receive the user data from the MN PDCP.

Meanwhile, in the SCG bearer, the UPF may transmit the user data of the DL to the MN PDCP of the MN (D1). Then, the MN PDCP may receive the user data from the UPF and transmit the received user data to the SN RLC (D2). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the MN PDCP (U2). Accordingly, the MN PDCP may transmit the user data to the UPF (U3). Then, the UPF may receive the user data from the MN PDCP.

Meanwhile, in the split bearer, the UPF may transmit the user data of the DL to the MN PDCP of the MN (D1). Then, the MN PDCP may receive the user data from the UPF and transmit the received user data to the MN RLC (D2A). Accordingly, the MN RLC may transmit the user data to the terminal (D3A). The terminal may receive the user data from the MN RLC. Simultaneously with the process, the MN PDCP may receive the user data from the UPF and transmit the received user data to the SN RLC (D2B). Accordingly, the SN RLC may transmit the user data to the terminal (D3B). The terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the MN PDCP (U2A). Accordingly, the MN PDCP may transmit the user data to the UPF (U3). Then, the UPF may receive the user data from the MN PDCP. In addition, the terminal may transmit the user data of the UL to the SN RLC (U1B). Then, the SN RLC may receive the user data from the terminal. The SN RLC may transmit the user data to the MN PDCP (U2B). Accordingly, the MN PDCP may transmit the user data to the UPF (U3). Then, the UPF may receive the user data from the MN PDCP. The data transmission described above may be based on FIG. 10A.

FIG. 19 is a flowchart illustrating a second embodiment of the process of transmitting user data.

Referring to FIG. 19, in the MCG bearer, the UPF may transmit the user data of the DL to the MN PDCP of the SN (D1). Then, the SN PDCP may receive the user data from the UPF and transmit the received user data to the MN RLC (D2). Accordingly, the MN RLC may transmit the user data to the terminal (D3). The terminal may receive the user data from the MN RLC.

Meanwhile, in the MCG bearer, the terminal may transmit user data of the UL to the MN RLC (U1). Then, the MN RLC may receive the user data from the terminal. The MN RLC may transmit the user data to the SN PDCP (U2). Accordingly, the MN PDCP may transmit the user data to the UPF (U3). Then, the UPF may receive the user data from the MN PDCP.

Meanwhile, in the SCG bearer, the UPF may transmit the user data of the DL to the MN PDCP of the MN (D1). Then, the MN PDCP may receive the user data from the UPF and transmit the received user data to the SN RLC (D2). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the MN PDCP (U2). Accordingly, the MN PDCP may transmit the user data to the UPF (U3). Then, the UPF may receive the user data from the MN PDCP.

Meanwhile, in the split bearer, the UPF may transmit the user data of the DL to the MN PDCP of the MN (D1). Then, the MN PDCP may receive the user data from the UPF and transmit the received user data to the MN RLC (D2A). Accordingly, the MN RLC may transmit the user data to the terminal (D3A). The terminal may receive the user data from the MN RLC. Simultaneously with the process, the MN PDCP may receive the user data from the UPF and transmit the received user data to the SN RLC (D2B). Accordingly, the SN RLC may transmit the user data to the terminal (D3B). The terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the MN PDCP (U2A). Accordingly, the MN PDCP may transmit the user data to the UPF (U3). Then, the UPF may receive the user data from the MN PDCP. In addition, the terminal may transmit the user data of the UL to the SN RLC (U1B). Then, the SN RLC may receive the user data from the terminal. The SN RLC may transmit the user data to the MN PDCP (U2B). Accordingly, the MN PDCP may transmit the user data to the UPF (U3). Then, the UPF may receive the user data from the MN PDCP. The data transmission described above may be based on FIG. 10D.

FIG. 20 is a flowchart illustrating a third embodiment of the process of transmitting user data.

Referring to FIG. 20, in the MCG bearer, the UPF may transmit the user data of the DL to the MN PDCP of the MN (D1). Then, the MN PDCP may receive the user data from the UPF and transmit the received user data to the MN RLC (D2). Accordingly, the MN RLC may transmit the user data to the terminal (D3). The terminal may receive the user data from the MN RLC.

Meanwhile, in the MCG bearer, the terminal may transmit user data of the UL to the MN RLC (U1). Then, the MN RLC may receive the user data from the terminal. The MN RLC may transmit the user data to the MN PDCP (U2). Accordingly, the MN PDCP may transmit the user data to the UPF (U3). Then, the UPF may receive the user data from the MN PDCP.

Meanwhile, in the SCG bearer, the UPF may transmit the user data of the DL to the SN PDCP of the SN (D1). Then, the SN PDCP may receive the user data from the UPF and transmit the received user data to the SN RLC (D2). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the MN PDCP (U2). Accordingly, the MN PDCP may transmit the user data to the UPF (U3). Then, the UPF may receive the user data from the MN PDCP.

Meanwhile, in the split bearer, the UPF may transmit the user data of the DL to the SN PDCP of the SN (D1). Then, the SN PDCP may receive the user data from the UPF and transmit the received user data to the SN RLC (D2A). Accordingly, the SN RLC may transmit the user data to the terminal (D3A). The terminal may receive the user data from the SN RLC. Simultaneously with the process, the SN PDCP may receive the user data from the UPF and transmit the received user data to the MN RLC (D2B). Accordingly, the MN RLC may transmit the user data to the terminal (D3B). The terminal may receive the user data from the MN RLC.

Meanwhile, in the split bearer, the terminal may transmit user data of the UL to the MN RLC (U1A). Then, the MN RLC may receive the user data from the terminal. The MN RLC may transmit the user data to the SN PDCP (U2A). Accordingly, the SN PDCP may transmit the user data to the UPF (U3). Then, the UPF may receive the user data from the SN PDCP. In addition, the terminal may transmit the user data of the UL to the SN RLC (U1B). Then, the SN RLC may receive the user data from the terminal. The SN RLC may transmit the user data to the SN PDCP (U2B). Accordingly, the SN PDCP may transmit the user data to the UPF (U3B). Then, the UPF may receive the user data from the SN PDCP. The data transmission described above may be based on FIG. 10E.

FIG. 21 is a flowchart illustrating a fourth embodiment of the process of transmitting user data.

Referring to FIG. 21, in the MCG bearer, the UPF may transmit the user data of the DL to the MN PDCP of the SN (D1). Then, the SN PDCP may receive the user data from the UPF and transmit the received user data to the MN RLC (D2). Accordingly, the MN RLC may transmit the user data to the terminal (D3). The terminal may receive the user data from the MN RLC.

Meanwhile, in the MCG bearer, the terminal may transmit user data of the UL to the MN RLC (U1). Then, the MN RLC may receive the user data from the terminal. The MN RLC may transmit the user data to the SN PDCP (U2). Accordingly, the MN PDCP may transmit the user data to the UPF (U3). Then, the UPF may receive the user data from the MN PDCP.

Meanwhile, in the SCG bearer, the UPF may transmit the user data of the DL to the SN PDCP of the SN (D1). Then, the SN PDCP may receive the user data from the UPF and transmit the received user data to the SN RLC (D2). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the SN PDCP (U2). Accordingly, the SN PDCP may transmit the user data to the UPF (U3). Then, the UPF may receive the user data from the SN PDCP.

Meanwhile, in the split bearer, the UPF may transmit the user data of the DL to the SN PDCP of the SN (D1). Then, the SN PDCP may receive the user data from the UPF and transmit the received user data to the MN RLC (D2A). Accordingly, the MN RLC may transmit the user data to the terminal (D3A). The terminal may receive the user data from the MN RLC. Simultaneously with the process, the SN PDCP may receive the user data from the UPF and transmit the received user data to the SN RLC (D2B). Accordingly, the SN RLC may transmit the user data to the terminal (D3B). The terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the SN PDCP (U2A). Accordingly, the SN PDCP may transmit the user data to the UPF (U3). Then, the UPF may receive the user data from the MN PDCP. In addition, the terminal may transmit the user data of the UL to the SN RLC (U1B). Then, the SN RLC may receive the user data from the terminal. The SN RLC may transmit the user data to the SN PDCP (U2B). Accordingly, the SN PDCP may transmit the user data to the UPF (U3). Then, the UPF may receive the user data from the MN PDCP. The data transmission described above may be based on FIG. 10H.

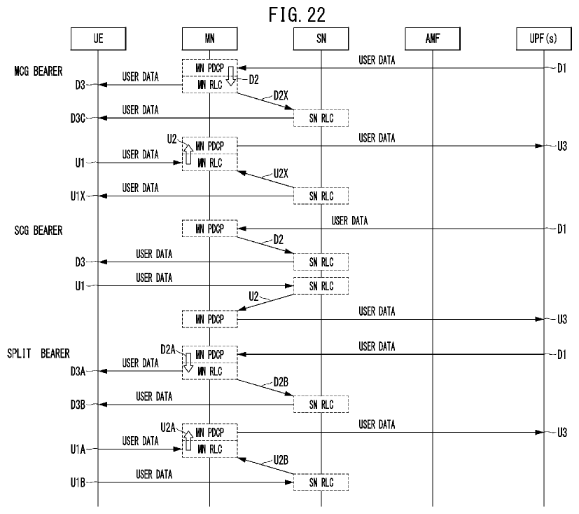

FIG. 22 is a flowchart illustrating a fifth embodiment of the process of transmitting user data.

Referring to FIG. 22, in the MCG bearer, the UPF may transmit the user data of the DL to the MN PDCP of the MN (D1). Then, the MN PDCP may receive the user data from the UPF and transmit the received user data to the MN RLC (D2). However, the MN RLC may not transmit the user data to the terminal due to the blocking of the DL path. In contrast, the MN PDCP may receive the user data from the UPF and transmit the received user data to the SN RLC (D2X). Accordingly, the SN RLC may receive the user data from the MN PDCP and transmit the received user data to the terminal (D3X). Then, the terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the MN PDCP (U2). Accordingly, the MN PDCP may transmit the user data to the UPF (U3). Then, the UPF may receive the user data from the MN PDCP. In addition, the terminal may transmit the user data of the UL to the SN RLC (U1X). Then, the SN RLC may receive the user data from the terminal. The SN RLC may transmit the user data to the MN PDCP (U2X). Accordingly, the MN PDCP may transmit the user data to the UPF (U3). Then, the UPF may receive the user data from the MN PDCP.

Meanwhile, in the SCG bearer, the UPF may transmit the user data of the DL to the MN PDCP of the MN (D1). Then, the MN PDCP may receive the user data from the UPF and transmit the received user data to the SN RLC (D2). Accordingly, the SN RLC may receive the user data from the MN PDCP and transmit the received user data to the terminal (D3). Then, the terminal may receive the user data from the SN RLC. In addition, the terminal may transmit the user data of the UL to the SN RLC (U1). Then, the SN RLC may receive the user data from the terminal. The SN RLC may transmit the user data to the MN PDCP (U2). Accordingly, the MN PDCP may transmit the user data to the UPF (U3). Then, the UPF may receive the user data from the SN PDCP.

Meanwhile, in the SCG bearer, the UPF may transmit the user data of the DL to the MN PDCP of the MN (D1). Then, the MN PDCP may receive the user data from the UPF and transmit the received user data to the MN RLC (D2A). However, the MN RLC may not transmit the user data to the terminal. In this case, the MN PDCP may transmit the user data to the SN RLC of the SN (D2B). Accordingly, the SN RLC may receive the user data from the MN PDCP and transmit the received user data to the terminal (D3B).

Meanwhile, in the split bearer, the terminal may transmit user data of the UL to the MN RLC (U1A). Then, the MN RLC may receive the user data from the terminal. The MN RLC may transmit the user data to the MN PDCP (U2A). Accordingly, the MN PDCP may transmit the user data to the UPF (U3). Then, the UPF may receive the user data from the MN PDCP. In addition, the terminal may transmit the user data of the UL to the SN RLC (U1B). Then, the SN RLC may receive the user data from the terminal. The SN RLC may transmit the user data to the MN PDCP (U2B). Accordingly, the MN PDCP may transmit the user data to the UPF (U3). Then, the UPF may receive the user data from the MN PDCP. The data transmission described above may be based on FIG. 12A.

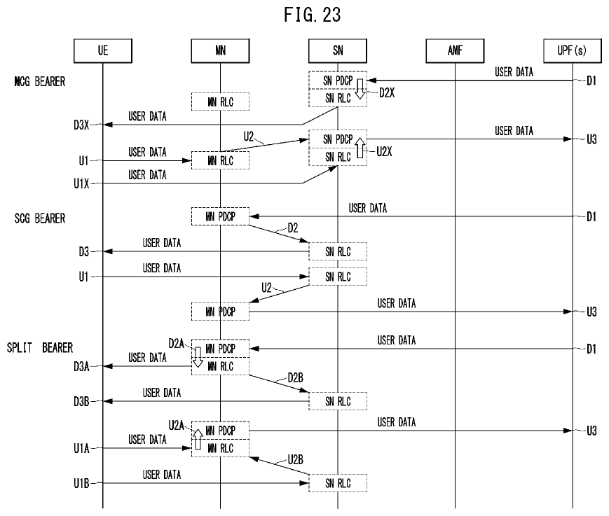

FIG. 23 is a flowchart illustrating a sixth embodiment of the process of transmitting user data.

Referring to FIG. 23, in the MCG bearer, the UPF may transmit the user data of the DL to the SN PDCP of the SN (D1). However, the SN PDCP may receive the user data from the UPF and may not transmit the received user data to the MN RLC. In contrast, the SN PDCP may receive the user data from the UPF and transmit the received user data to the SN RLC (D2X). Accordingly, the SN RLC may transmit the user data to the terminal (D3X). The terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the SN PDCP (U2). Accordingly, the SN PDCP may transmit the user data to the UPF (U3). Then, the UPF may receive the user data from the SN PDCP. In contrast, the terminal may transmit the user data of the UL to the SN RLC (U1X). Then, the SN RLC may receive the user data from the terminal. The SN RLC may transmit the user data to the SN PDCP (U2X). Then, the SN PDCP may receive the user data from the SN RLC. Accordingly, the SN PDCP may transmit the user data to the UPF (U3). Then, the UPF may receive the user data from the SN PDCP.

Meanwhile, in the SCG bearer, the UPF may transmit the user data of the DL to the MN PDCP of the MN (D1). Then, the MN PDCP may receive the user data from the UPF and transmit the received user data to the SN RLC (D2). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the MN PDCP (U2). Accordingly, the MN PDCP may transmit the user data to the UPF (U3). Then, the UPF may receive the user data from the MN PDCP.

Meanwhile, in the SCG bearer, the UPF may transmit the user data of the DL to the MN PDCP of the MN (D1). Then, the MN PDCP may receive the user data from the UPF and transmit the received user data to the MN RLC (D2A). The MN RLC may receive the user data from the MN PDCP. However, the MN RLC may not transmit the user data to the terminal. Accordingly, the MN PDCP may transmit the user data to the SN PDCP (D2B). The SN RLC may receive the user data from the MN PDCP. The SN RLC may transmit the user data to the terminal (D3B). The terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the MN PDCP (U2A). Accordingly, the MN PDCP may transmit the user data to the UPF (U3). Then, the UPF may receive the user data from the MN PDCP. In addition, the terminal may transmit the user data of the UL to the SN RLC (U1B). Then, the SN RLC may receive the user data from the terminal. The SN RLC may transmit the user data to the MN PDCP (U2B). Accordingly, the MN PDCP may transmit the user data to the UPF (U3). Then, the UPF may receive the user data from the MN PDCP. The data transmission described above may be based on FIG. 12D.

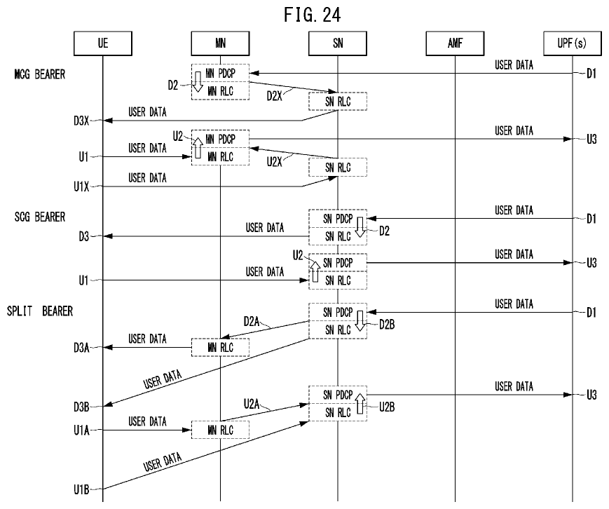

FIG. 24 is a flowchart illustrating a seventh embodiment of the process of transmitting user data.

Referring to FIG. 24, in the MCG bearer, the UPF may transmit the user data of the DL to the MN PDCP of the MN (D1). Then, the MN PDCP may receive the user data from the UPF and may not transmit the received user data to the MN RLC. In contrast, the MN PDCP may receive the user data from the UPF and transmit the received user data to the SN RLC (D2X). Accordingly, the SN RLC may receive the user data from the SN PDCP and transmit the received user data to the terminal (D3X). Then, the terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the MN PDCP (U2). Accordingly, the MN PDCP may transmit the user data to the UPF (U3). Then, the UPF may receive the user data from the MN PDCP. In addition, the terminal may transmit the user data of the UL to the SN RLC (U1X). Then, the SN RLC may receive the user data from the terminal. The SN RLC may transmit the user data to the MN PDCP (U2X). Accordingly, the MN PDCP may transmit the user data to the UPF (U3). Then, the UPF may receive the user data from the MN PDCP.

Meanwhile, in the SCG bearer, the UPF may transmit the user data of the DL to the SN PDCP of the SN (D1). Then, the SN PDCP may receive the user data from the UPF and transmit the received user data to the SN RLC (D2). Accordingly, the SN RLC may receive the user data from the SN PDCP and transmit the received user data to the terminal (D3). Then, the terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the SN PDCP (U2). Accordingly, the SN PDCP may transmit the user data to the UPF (U3). Then, the UPF may receive the user data from the SN PDCP.

Meanwhile, in the split bearer, the UPF may transmit the user data of the DL to the SN PDCP of the SN (D1). However, the SN RLC may not transmit the user data to the MN RLC due to the blocking of the DL path directed to the MN. In contrast, the SN PDCP may receive the user data from the UPF and transmit the received user data to the SN RLC (D2B). Accordingly, the SN RLC may receive the user data from the SN PDCP and transmit the received user data to the terminal (D3B). Then, the terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the SN PDCP (U2A). Accordingly, the SN PDCP may transmit the user data to the UPF (U3). Then, the UPF may receive the user data from the SN PDCP. In addition, the terminal may transmit the user data of the UL to the SN RLC (U1B). Then, the SN RLC may receive the user data from the terminal. The SN RLC may transmit the user data to the SN PDCP (U2B). Accordingly, the SN PDCP may transmit the user data to the UPF (U3). Then, the UPF may receive the user data from the SN PDCP. The data transmission described above may be based on FIG. 12E.

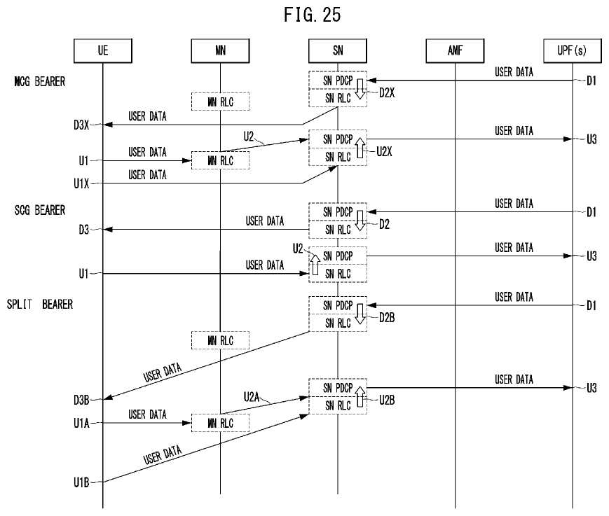

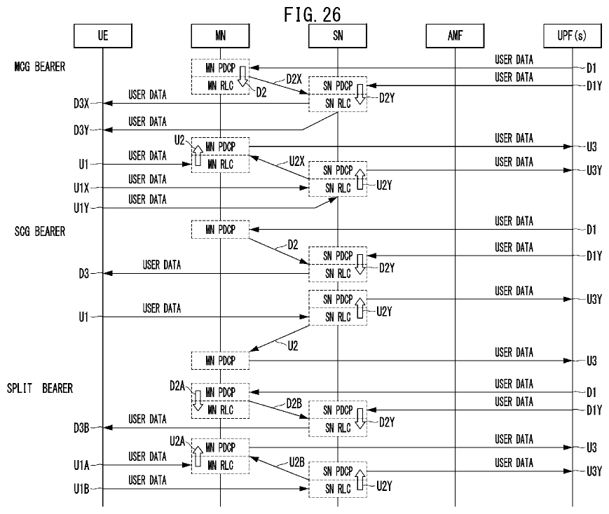

FIG. 25 is a flowchart illustrating an eighth embodiment of the process of transmitting user data.

Referring to FIG. 25, in the MCG bearer, the UPF may transmit the user data of the DL to the SN PDCP of the SN (D1). However, the SN PDCP may receive the user data from the UPF and may not transmit the received user data to the MN RLC. In contrast, the SN PDCP may receive the user data from the UPF and transmit the received user data to the SN RLC (D2X). Accordingly, the SN RLC may transmit the user data to the terminal (D3X). The terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the SN PDCP (U2). Accordingly, the SN PDCP may transmit the user data to the UPF (U3). Then, the UPF may receive the user data from the SN PDCP. In contrast, the terminal may transmit the user data of the UL to the SN RLC (U1X). Then, the SN RLC may receive the user data from the terminal. The SN RLC may transmit the user data to the SN PDCP (U2X). Accordingly, the SN PDCP may transmit the user data to the UPF (U3). Then, the UPF may receive the user data from the SN PDCP.

Meanwhile, in the SCG bearer, the UPF may transmit the user data of the DL to the SN PDCP of the SN (D1). Then, the SN PDCP may receive the user data from the UPF and transmit the received user data to the SN RLC (D2). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the SN PDCP (U2). Accordingly, the SN PDCP may transmit the user data to the UPF (U3). Then, the UPF may receive the user data from the SN PDCP.

Meanwhile, in the split bearer, the UPF may transmit the user data of the DL to the SN PDCP of the SN (D1). Then, the SN PDCP may receive the user data from the UPF and may not transmit the received user data to the MN RLC. However, the SN PDCP may receive the user data from the UPF and transmit the received user data to the SN RLC (D2B). Accordingly, the SN RLC may transmit the user data to the terminal (D3B). The terminal may receive the user data from the SN RLC.

Meanwhile, in the split bearer, the terminal may transmit user data of the UL to the MN RLC (U1). Then, the MN RLC may receive the user data from the terminal. The MN RLC may transmit the user data to the SN PDCP (U2A). Accordingly, the SN PDCP may transmit the user data to the UPF (U3). Then, the UPF may receive the user data from the SN PDCP. In addition, the terminal may transmit the user data of the UL to the SN RLC (U1B). Then, the SN RLC may receive the user data from the terminal. The SN RLC may transmit the user data to the SN PDCP (U2B). Accordingly, the SN PDCP may transmit the user data to the UPF (U3). Then, the UPF may receive the user data from the SN PDCP. The data transmission described above may be based on FIG. 12H.

FIG. 26 is a flowchart illustrating a fifth embodiment of the process of transmitting user data.

Referring to FIG. 26, in the MCG bearer, the UPF may transmit the user data of the DL to the MN PDCP of the MN (D1). Then, the MN PDCP may receive the user data from the UPF and transmit the received user data to the MN RLC (D2). However, the MN RLC may not transmit the user data to the terminal due to the blocking of the DL path. In contrast, the MN PDCP may receive the user data from the UPF and transmit the received user data to the SN RLC (D2X). Accordingly, the SN RLC may receive the user data from the SN PDCP and transmit the received user data to the terminal (D3X). Then, the terminal may receive the user data from the SN RLC. Simultaneously, the UPF may transmit the user data of the DL to the SN PDCP of the SN (DIY). Then, the SN PDCP may receive the user data from the UPF and transmit the received user data to the SN RLC (D2Y). Accordingly, the SN RLC may receive the user data from the SN PDCP and transmit the received user data to the terminal (D3Y). Then, the terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the MN PDCP (U2). Accordingly, the MN PDCP may transmit the user data to the UPF (U3). Then, the UPF may receive the user data from the MN PDCP. In addition, the terminal may transmit the user data of the UL to the SN RLC (U1X). Then, the SN RLC may receive the user data from the terminal. The SN RLC may transmit the user data to the MN PDCP (U2X). Accordingly, the MN PDCP may transmit the user data to the UPF (U3). Then, the UPF may receive the user data from the MN PDCP. In addition, the terminal may transmit the user data of the UL to the SN RLC (U1 Y). Then, the SN RLC may receive the user data from the terminal. The SN RLC may transmit the user data to the SN PDCP (U2Y). Accordingly, the SN PDCP may transmit the user data to the UPF (U3Y). Then, the UPF may receive the user data from the SN PDCP.

Meanwhile, in the SCG bearer, the UPF may transmit the user data of the DL to the MN PDCP of the MN (D1). Then, the MN PDCP may receive the user data from the UPF and transmit the received user data to the SN RLC (D2). Accordingly, the SN RLC may receive the user data from the MN PDCP and transmit the received user data to the terminal (D3). Then, the terminal may receive the user data from the SN RLC. Simultaneously, the UPF may transmit the user data of the DL to the SN PDCP of the SN (DIY). Then, the SN PDCP may receive the user data from the UPF and transmit the received user data to the SN RLC (D2Y). Accordingly, the SN RLC may receive the user data from the SN PDCP and transmit the received user data to the terminal (D3). Then, the terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the MN PDCP (U2). Accordingly, the MN PDCP may transmit the user data to the UPF (U3). Then, the UPF may receive the user data from the MN PDCP. In addition, the SN RLC may transmit the user data to the SN PDCP (U2Y). Accordingly, the SN PDCP may transmit the user data to the UPF (U3Y). Then, the UPF may receive the user data from the SN PDCP.

Meanwhile, in the SCG bearer, the UPF may transmit the user data of the DL to the MN PDCP of the MN (D1). Then, the MN PDCP may receive the user data from the UPF and transmit the received user data to the MN RLC (D2A). However, the MN RLC may not transmit the user data to the terminal due to the blocking of the DL path. In contrast, the MN PDCP may receive the user data from the UPF and transmit the received user data to the SN RLC (D2B). Accordingly, the SN RLC may receive the user data from the SN PDCP and transmit the received user data to the terminal (D3B). Then, the terminal may receive the user data from the SN RLC. Simultaneously, the UPF may transmit the user data of the DL to the SN PDCP of the SN (DIY). Then, the SN PDCP may receive the user data from the UPF and transmit the received user data to the SN RLC (D2Y). Accordingly, the SN RLC may receive the user data from the SN PDCP and transmit the received user data to the terminal (D3B). Then, the terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the MN PDCP (U2A). Accordingly, the MN PDCP may transmit the user data to the UPF (U3). Then, the UPF may receive the user data from the MN PDCP. In addition, the terminal may transmit the user data of the UL to the SN RLC (U1B). Then, the SN RLC may receive the user data from the terminal. The SN RLC may transmit the user data to the MN PDCP (U2B). Accordingly, the MN PDCP may transmit the user data to the UPF (U3). Then, the UPF may receive the user data from the MN PDCP. In addition, the SN RLC may transmit the user data to the SN PDCP (U2Y). Accordingly, the SN PDCP may transmit the user data to the UPF (U3Y). Then, the UPF may receive the user data from the SN PDCP. The data transmission described above may be based on FIG. 14A.

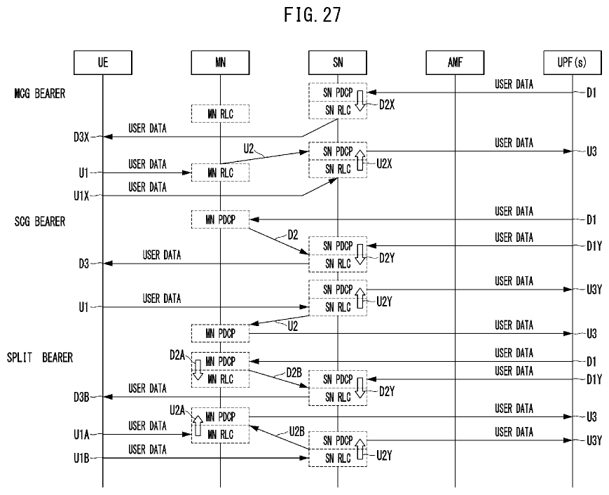

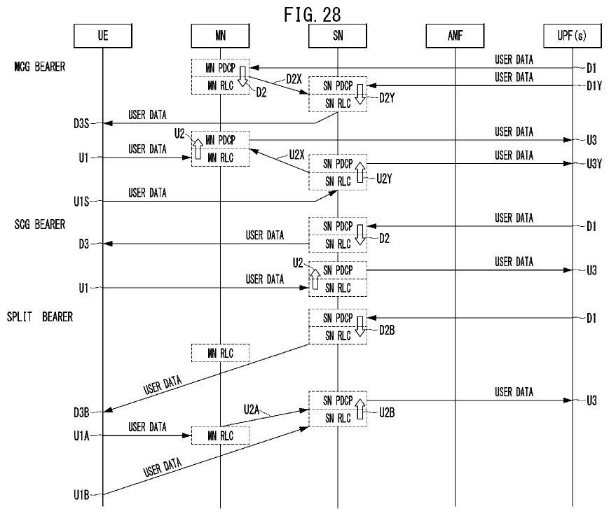

FIG. 27 is a flowchart illustrating a tenth embodiment of the process of transmitting user data.

Referring to FIG. 27, in the MCG bearer, the UPF may transmit the user data of the DL to the SN PDCP of the SN (D1). However, the SN PDCP may receive the user data from the UPF and may not transmit the received user data to the MN RLC. In contrast, the SN PDCP may receive the user data from the UPF and transmit the received user data to the SN RLC (D2X). Accordingly, the SN RLC may transmit the user data to the terminal (D3X). The terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the SN PDCP (U2). Accordingly, the SN PDCP may transmit the user data to the UPF (U3). Then, the UPF may receive the user data from the SN PDCP. In contrast, the terminal may transmit the user data of the UL to the SN RLC (U1X). Then, the SN RLC may receive the user data from the terminal. The SN RLC may transmit the user data to the SN PDCP (U2X). Accordingly, the SN PDCP may transmit the user data to the UPF (U3). Then, the UPF may receive the user data from the SN PDCP.

Meanwhile, in the SCG bearer, the UPF may transmit the user data of the DL to the MN PDCP of the MN (D1). Then, the MN PDCP may receive the user data from the UPF and transmit the received user data to the SN RLC (D2). Accordingly, the SN RLC may transmit the user data to the terminal (D3). The terminal may receive the user data from the SN RLC. In addition, the UPF may transmit the user data of the DL to the SN PDCP of the MN (DIY). Then, the SN PDCP may receive the user data from the UPF and transmit the received user data to the SN RLC (D2Y). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the MN PDCP (U2). Accordingly, the MN PDCP may transmit the user data to the UPF (U3). Then, the UPF may receive the user data from the MN PDCP. In addition, the SN RLC may transmit the user data to the SN PDCP (U2Y). Accordingly, the SN PDCP may transmit the user data to the UPF (U3Y). Then, the UPF may receive the user data from the SN PDCP.

Meanwhile, in the SCG bearer, the UPF may transmit the user data of the DL to the MN PDCP of the MN (D1). Then, the MN PDCP may receive the user data from the UPF and transmit the received user data to the MN RLC (D2A). However, the MN RLC may not receive the user data from the MN PDCP and transmit the received user data to the terminal. Accordingly, the MN PDCP may transmit the user data to the SN RLC (D2B). Then, the SN RLC may receive the user data from the MN PDCP and transmit the received user data to the terminal (D3B). The terminal may receive the user data from the SN RLC. In addition, the UPF may transmit the user data of the DL to the SN PDCP of the SN (D1Y). Then, the SN PDCP may receive the user data from the UPF and transmit the received user data to the SN RLC (D2Y). Then, the SN RLC may receive the user data from the MM PDCP and transmit the received user data to the terminal (D3B). The terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the MN PDCP (U2A). Accordingly, the MN PDCP may transmit the user data to the UPF (U3). Then, the UPF may receive the user data from the MN PDCP. In addition, the terminal may transmit the user data of the UL to the SN RLC (U1B). Then, the SN RLC may receive the user data from the terminal. The SN RLC may transmit the user data to the MN PDCP (U2B). Accordingly, the MN PDCP may transmit the user data to the UPF (U3). Then, the UPF may receive the user data from the MN PDCP. In addition, the SN RLC may transmit the user data to the SN PDCP (U2Y). Accordingly, the SN PDCP may transmit the user data to the UPF (U3Y). Then, the UPF may receive the user data from the SN PDCP. The data transmission described above may be based on FIG. 14D.

FIG. 28 is a flowchart illustrating an eleventh embodiment of the process of transmitting user data.

Referring to FIG. 28, in the MCG bearer, the UPF may transmit the user data of the DL to the MN PDCP of the MN (D1). However, the MN PDCP may receive the user data from the UPF and may not transmit the received user data to the MN RLC. In contrast, the MN PDCP may receive the user data from the UPF and transmit the received user data to the SN RLC (D2X). Accordingly, the SN RLC may receive the user data from the SN PDCP and transmit the received user data to the terminal (D3X). Then, the terminal may receive the user data from the SN RLC. In addition, the UPF may transmit the user data of the DL to the SN PDCP of the SN (D1Y). Then, the SN PDCP may receive the user data from the UPF and transmit the received user data to the SN RLC (D2Y). Accordingly, the SN RLC may receive the user data from the SN PDCP and transmit the received user data to the terminal (D3X). Then, the terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the MN PDCP (U2). Accordingly, the MN PDCP may transmit the user data to the UPF (U3). Then, the UPF may receive the user data from the MN PDCP. In addition, the terminal may transmit the user data of the UL to the SN RLC (U1X). Then, the SN RLC may receive the user data from the terminal. The SN RLC may transmit the user data to the SN PDCP (U2Y). Accordingly, the SN PDCP may transmit the user data to the UPF (U3Y). Then, the UPF may receive the user data from the SN PDCP.

Meanwhile, in the SCG bearer, the UPF may transmit the user data of the DL to the SN PDCP of the SN (D1). Then, the SN PDCP may receive the user data from the UPF and transmit the received user data to the SN RLC (D2). Accordingly, the SN RLC may receive the user data from the SN PDCP and transmit the received user data to the terminal (D3). Then, the terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the SN PDCP (U2). Accordingly, the SN PDCP may transmit the user data to the UPF (U3). Then, the UPF may receive the user data from the SN PDCP.

Meanwhile, in the split bearer, the UPF may transmit the user data of the DL to the SN PDCP of the SN (D1). Then, the SN PDCP may receive the user data from the UPF and may not transmit the received user data to the MN RLC. In contrast, the SN PDCP may receive the user data from the UPF and transmit the received user data to the SN RLC (D2B). Accordingly, the SN RLC may receive the user data from the SN PDCP and transmit the received user data to the terminal (D3B). Then, the terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the SN PDCP (U2A). Accordingly, the SN PDCP may transmit the user data to the UPF (U3). Then, the UPF may receive the user data from the SN PDCP. In addition, the terminal may transmit the user data of the UL to the SN RLC (U1B). Then, the SN RLC may receive the user data from the terminal. The SN RLC may transmit the user data to the SN PDCP (U2B). Accordingly, the SN PDCP may transmit the user data to the UPF (U3). Then, the UPF may receive the user data from the SN PDCP. The data transmission described above may be based on FIG. 14E.

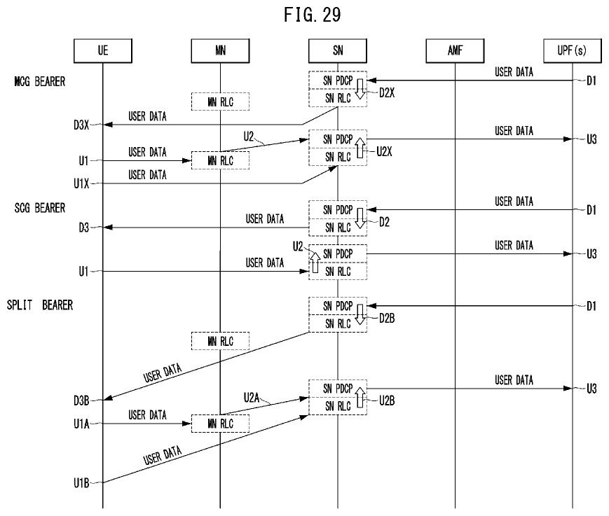

FIG. 29 is a flowchart illustrating a twelfth embodiment of the process of transmitting user data.

Referring to FIG. 29, in the MCG bearer, the UPF may transmit the user data of the DL to the SN PDCP of the SN (D1). However, the SN PDCP may receive the user data from the UPF and may not transmit the received user data to the MN RLC. In contrast, the SN PDCP may receive the user data from the UPF and transmit the received user data to the SN RLC (D2X). Accordingly, the SN RLC may transmit the user data to the terminal (D3X). The terminal may receive the user data from the SN RLC.

Meanwhile, in the MCG bearer, the terminal may transmit user data of the UL to the MN RLC (U1). Then, the MN RLC may receive the user data from the terminal. The MN RLC may transmit the user data to the SN PDCP (U2). Accordingly, the SN PDCP may transmit the user data to the UPF (U3). Then, the UPF may receive the user data from the SN PDCP. In contrast, the terminal may transmit the user data of the UL to the SN RLC (U1X). Then, the SN RLC may receive the user data from the terminal. The SN RLC may transmit the user data to the SN PDCP (U2X). Accordingly, the SN PDCP may transmit the user data to the UPF (U3). Then, the UPF may receive the user data from the MN PDCP.

Meanwhile, in the SCG bearer, the UPF may transmit the user data of the DL to the MN PDCP of the MN (D1). Then, the SN PDCP may receive the user data from the UPF and transmit the received user data to the SN RLC (D2). Accordingly, the SN RLC may transmit the user data to the terminal (D3). The terminal may receive the user data from the SN RLC.

Meanwhile, in the SCG bearer, the terminal may transmit user data of the UL to the SN RLC (U1). Then, the SN RLC may receive the user data from the terminal. The SN RLC may transmit the user data to the SN PDCP (U2). Accordingly, the SN PDCP may transmit the user data to the UPF (U3). Then, the UPF may receive the user data from the SN PDCP.

Meanwhile, in the split bearer, the UPF may transmit the user data of the DL to the MN PDCP of the MN (D1). However, the SN PDCP may receive the user data from the UPF and may not transmit the received user data to the MN RLC. However, the SN PDCP may receive the user data from the UPF and transmit the received user data to the SN RLC (D2B). Accordingly, the SN RLC may transmit the user data to the terminal (D3B). The terminal may receive the user data from the SN RLC.

Meanwhile, in the split bearer, the terminal may transmit user data of the UL to the MN RLC (U1A). Then, the MN RLC may receive the user data from the terminal. The MN RLC may transmit the user data to the SN PDCP (U2A). Accordingly, the SN PDCP may transmit the user data to the UPF (U3). Then, the UPF may receive the user data from the SN PDCP. In addition, the terminal may transmit the user data of the UL to the SN RLC (U1B). Then, the SN RLC may receive the user data from the terminal. The SN RLC may transmit the user data to the SN PDCP (U2B). Accordingly, the SN PDCP may transmit the user data to the UPF (U3). Then, the UPF may receive the user data from the SN PDCP. The data transmission described above may be based on FIG. 14H.

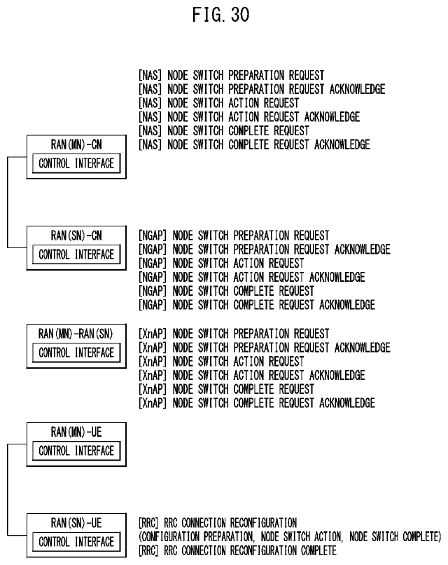

FIG. 30 is a conceptual diagram illustrating a first embodiment of usable message types of a control interface.

Referring to FIG. 30, the MN-CN control interface of the RAN may use a node switch preparation request/node switch preparation request acknowledge for node switching-related preparation and a node switch action request/node switch action request acknowledge for node switching execution. Alternatively, the RAN-CN control interface may use a node switch complete request/node switch complete request acknowledge. In this way, the MN-CN control interface of the RAN may add information elements of the node switch complete request/node switch complete request acknowledge.

The SN-CN control interface of the RAN may use the node switch preparation request/node switch preparation request acknowledge for node switching-related preparation and the node switch action request/node switch action request acknowledge for node switching execution. Alternatively, the SN-CN control interface of the RAN may use the node switch complete request/node switch complete request acknowledge. In this way, the RAN-CN interface may add the information elements of the node switch complete request/node switch complete request acknowledge.

The SN control interface of the MN-RAN of the RAN may use messages of the node switch preparation request/node switch preparation request acknowledge for node switching-related preparation and the node switch action request/node switch action request acknowledge for node switching execution. In addition, the SN control interface of the MN-RAN of the RAN may use the node switch complete request/node switch complete request acknowledge. In this way, the SN control interface of the MN-RAN of the RAN may add the information elements of the node switch complete request/node switch complete request acknowledge.

A control interface of SN-UE of the RAN may use RRC connection reconfiguration/RRC connection reconfiguration complete messages. Alternatively, the control interface of the SN-UE of the RAN may use configuration preparation/node switch action/node switch complete messages.

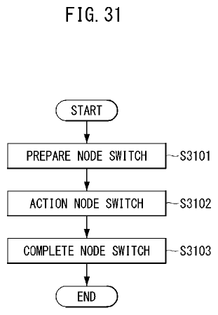

FIG. 31 is a flowchart illustrating a first embodiment of the method of switching from an MN to an SN in a communication system.

Referring to FIG. 31, the switching method may include a node switch preparation operation (S3101), a node switching action operation (S3102), and a node switching complete operation (S3103).

Here, in the node switch preparation operation, the SN may generate an instance for passive SDS from MN to the SN, and configure the UP path of the MN and the SN. In addition, in the node switch preparation operation, the SN may generate an instance for the SDS from the active MN to the SN, and generate the UP path of the MN and the SN and the UP path of the SN and the CN.

Next, in the node switching action operation, the MN may transmit the node switch action request message to the SN. Then, the SN may receive the node switch action request message from the MN. Then, the SN may transmit the node switch action request message to the AMF. In this case, the SN may transmit the RAN UE NGAP ID (MN) received by the MN and the RAN UE NGAP ID (SN) generated based on the AMF UE NGAP ID to the AMF. Then, the AMF may receive the node switch action request message including the RAN UE NGAP ID (SN) from the SN. The AMF may replace the RAN UE NGAP ID (MN) with the RAN UE NGAP ID (SN). Thereafter, the AMF may transmit the node switch action request acknowledge message to the SN. The SN may receive the node switch action request acknowledge message from the AMF. The SN may transmit the node switch action request acknowledge message to the MN. Accordingly, the MN may determine the performance of the SDS by receiving the node switch action request acknowledge message from the SN.

Next, in the node switching complete operation, the SN may transmit the node switch complete request message to the MN (S3401). Then, the MN may receive the node switch complete request message from the SN. In this case, the MN may delete the MCG PDCP, the SCG PDCP, or the split PDCP therein. The MN may delete the MCG RLS therein. In addition, the MN may delete the internal path and the path with the SN in the linked MN related to the instance. Thereafter, the MN may transmit the node switch complete request acknowledge message to the SN. Then, the SN may receive the node switch complete request acknowledge message from the MN.

Then, the SN may transmit the node switch complete request message to the AMF. Then, the AMF may receive the node switch complete request message from the SN. The AMF may delete the RAN UE NGAP ID related to the MN from the control information related to the MN-CN control interface of the RAN on the MN and the CP. Of course, the MN may delete the RAN UE NGAP ID related to the MN from the control information related to the MN-CN control interface of the RAN. Meanwhile, the AMF may delete pieces of UP information related to the MCG/SCG/split bearer between the MN and the CN. Accordingly, the AMF may transmit the node switch complete request acknowledge message to the SN. Then, the SN may receive the node switch complete request acknowledge message from the AMF.

Meanwhile, the SN may transmit the RRC connection reconfiguration message to the terminal (S3405). Then, the terminal may receive the RRC connection reconfiguration message from the SN. The terminal may delete instances corresponding to the MCG PDCP, the SCG PDCP, or the split PDCP of the MN. The terminal may delete instances corresponding to the MCG RLS of the MN. In addition, the terminal may delete the internal paths of the linked terminal associated with these instances. Thereafter, the terminal may transmit an RRC connection reconfiguration acknowledge message to the SN (S3406). Then, the SN may receive the RRC connection reconfiguration acknowledge message from the terminal.

Meanwhile, the AMF may transmit the node switch complete request signal to the SN (S3407). Then, the SN may receive the node switch complete request signal from the AMF. Accordingly, the SN may transmit the node switch complete request signal to the terminal (S3408). Then, the terminal may receive the node switch complete request signal from the SN.

Meanwhile, the terminal may transmit a node switch action complete signal to the SN (S3409). Then, the SN may receive the node switch action complete signal from the terminal. Accordingly, the SN may transmit the node switch action complete signal to the AMF (S3410). Then, the AMF may receive the node switch complete request signal from the SN.

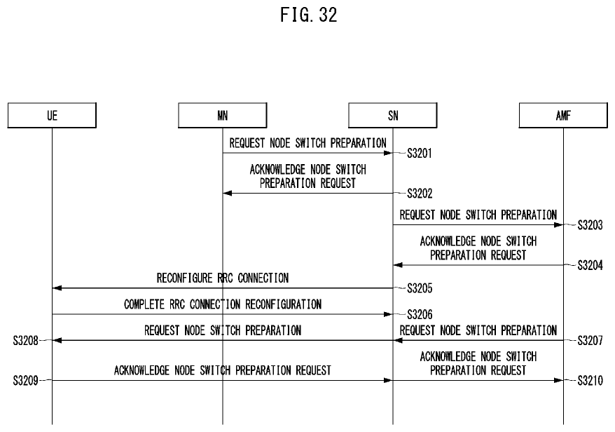

FIG. 32 is a flowchart illustrating a first embodiment of the node switch preparation operation of FIG. 31.

Referring to FIG. 32, the MN may generate a unique ID pair of the RAN UE NGAP ID (MN) and the AMF UE NGAP ID for the MN-CN control interface of the RAN. The MN may transmit the node switch preparation request message including the RAN UE NGAP ID (MN) and the AMF UE NGAP ID generated by the SN (S3201). Then, the SN may receive the node switch preparation request message from the MN. Accordingly, the SN may obtain the RAN UE NGAP ID (MN) and the AMF UE NGAP ID from the node switch preparation request message. The SN may generate the RAN UE NGAP ID (SN), which is an ID for the SN-CN control interface of the RAN, based on the acquired RAN UE NGAP ID (MN) and AMF UE NGAP ID.

Meanwhile, the node switch preparation request message may include UP path configuration information of the MN and the SN in the case of SDS from the passive MN to the SN. Alternatively, the node switch preparation request message may include the UP path configuration information of the MN and the SN and the UP path configuration information of the SN and the CN in the case of the SDS from the active MN to the SN. In addition, the node switch preparation request message may include configuration information on the instance to be configured in the SN according to the included UP path configuration information of the MN and SN. Alternatively, the node switch preparation request message may include the included UP path configuration information of the MN and SN and the configuration information on the instance to be configured in the SN according to the UP path configurations of the SN and the CN.

Accordingly, when the SN receives the node switch preparation request message, the SN may generate an instance according to the included configuration information and configure the UP path. Thereafter, the SN may transmit the node switch preparation request acknowledge message including the generated instance configuration information of the SN to the MN (S3202). Then, the MN may receive, from the SN, the node switch preparation request acknowledge message including the generated instance configuration information of the SN.

As an example, in the case of FIGS. 15A to 15C, the node switch preparation request message may include MCG RLS instance configuration information of the SN, and include UP path configuration information of the MCG PDCP of the MN and the MCG RLS of the SN. Accordingly, when the SN receives the node switch preparation request message, the SN may generate the MCG RLS instance according to the included configuration information and configure the UP paths of the MCG PDCP of MN and the MCG RLS of the SN.

As another example, in the case of FIGS. 15A to 15C, the node switch preparation request message may include MCG RLS instance configuration information of the SN, and include UP path configuration information of the MCG PDCP of the SN and the MCG RLS of the SN. Accordingly, when the SN receives the node switch preparation request message, the SN may generate the MCG RLS instance according to the included configuration information and configure the UP paths of the MCG PDCP of SN and the MCG RLS of the SN.

As another example, referring to FIG. 17A, the node switch preparation request message may include the MCG RLS instance configuration information, the MCG PDCP configuration information, the SCG PDCP configuration information, and the split PDCP configuration information of the SN. In addition, the node switch preparation request message may include the UP path configuration information of the MCG PDCP of the MN and the MCG RLS of the SN, UP path configuration information of the MCG PDCP of the SN and the MCG RLS of the SN, UP path configuration information of the SCG PDCP of the SN and the SCG RLS of the SN, and UP path configuration information of the split PDCP of the SN and the split RLC of the SN. Accordingly, when the SN receives the node switch preparation request message, the SN may generate an MCG PDCP instance, an SCG PDCP instance, a split PDCP instance, and an MCG RLS instance according to the included configuration information. In addition, the SN may configure the UP paths of the MCG PDCP of the MN and the MCG RLS of the SN, the UP paths of the SCG PDCP of the SN and the SCG RLS of the SN, and the UP paths of the split PDCP of the SN and the split RLC of the SN according to the configuration information included in the node switch preparation request message.

As another example, referring to FIG. 17B, the node switch preparation request message may include the MCG RLS instance configuration information, the MCG PDCP configuration information, and the split PDCP configuration information of the SN. In addition, the node switch preparation request message may include the UP path configuration information of the MCG PDCP of the MN and the MCG RLS of the SN, the UP path configuration information of the MCG PDCP of the SN and the MCG RLS of the SN, and the UP path configuration information of the split PDCP of the SN and the split RLC of the SN. Accordingly, when the SN receives the node switch preparation request message, the SN may generate the MCG PDCP instance, the split PDCP instance, and the MCG RLS instance according to the included configuration information. In addition, the SN may configure the UP paths of the MCG PDCP of the MN and the MCG RLS of the SN and the UP paths of the split PDCP of the SN and the split RLC of the SN according to the configuration information included in the node switch preparation request message.

As another example, referring to FIG. 17C, the node switch preparation request message may include the MCG RLS instance configuration information, the MCG PDCP configuration information, and the SCG PDCP configuration information of the SN. In addition, the node switch preparation request message may include the UP path configuration information of the MCG PDCP of the MN and the MCG RLS of the SN, the UP path configuration information of the MCG PDCP of the SN and the MCG RLS of the SN, and the UP path configuration information of the SCG PDCP of the SN and the SCG RLC of the SN. Accordingly, when the SN receives the node switch preparation request message, the SN may generate the MCG PDCP instance, the SCG PDCP instance, and the MCG RLS instance according to the included configuration information. In addition, the SN may configure the UP paths of the MCG PDCP of the MN and the MCG RLS of the SN and the UP paths of the SCG PDCP of the SN and the SCG RLC of the SN according to the configuration information included in the node switch preparation request message.

As another example, referring to FIG. 17D, the node switch preparation request message may include the MCG RLS instance configuration information, the SCG PDCP configuration information, and the split PDCP configuration information of the SN. In addition, the node switch preparation request message may include the UP path configuration information of the MCG PDCP of the SN and the MCG RLS of the SN, the UP path configuration information of the SCG PDCP of the SN and the SCG RLS of the SN, and the UP path configuration information of the split PDCP of the SN and the split RLC of the SN. Accordingly, when the SN receives the node switch preparation request message, the SN may generate the SCG PDCP instance, the split PDCP instance, and the MCG RLS instance according to the included configuration information. In addition, the SN may configure the UP paths of the MCG PDCP of the SN and the MCG RLS of the SN, the UP paths of the SCG PDCP of the SN and the SCG RLS of the SN, and the UP paths of the split PDCP of the SN and the split RLC of the SN according to the configuration information included in the node switch preparation request message.

As another example, referring to FIG. 17E, the node switch preparation request message may include the MCG RLS instance configuration information and the MCG PDCP configuration information of the SN. In addition, the node switch preparation request message may include the UP path configuration information of the MCG PDCP of the MN and the MCG RLS of the SN and the UP path configuration information of the MCG PDCP of the SN and the MCG RLS of the SN. Accordingly, when the SN receives the node switch preparation request message, the SN may generate the MCG PDCP instance and the MCG RLS instance according to the included configuration information. In addition, the SN may configure the UP paths of the MCG PDCP of the MN and the MCG RLS of the SN and the UP paths of the MCG PDCP of the SN and the MCG RLC of the SN according to the configuration information included in the node switch preparation request message.

As another example, referring to FIG. 17F, the node switch preparation request message may include the MCG RLS instance configuration information and the SCG PDCP configuration information of the SN. In addition, the node switch preparation request message may include the UP path configuration information of the MCG PDCP of the SN and the MCG RLS of the SN and the UP path configuration information of the SCG PDCP of the SN and the SCG RLS of the SN. Accordingly, when the SN receives the node switch preparation request message, the SN may generate the SCG PDCP instance and the MCG RLS instance according to the included configuration information. In addition, the SN may configure the UP paths of the MCG PDCP of the MN and the MCG RLS of the SN and the UP paths of the SCG PDCP of the SN and the SCG RLC of the SN according to the configuration information included in the node switch preparation request message.

As another example, referring to FIG. 17G, the node switch preparation request message may include the MCG RLS instance configuration information, the MCG PDCP configuration information, the SCG PDCP configuration information, and the split PDCP configuration information of the SN. In addition, the node switch preparation request message may include the UP path configuration information of the MCG PDCP of the MN and the MCG RLS of the SN, UP path configuration information of the MCG PDCP of the SN and the MCG RLS of the SN, UP path configuration information of the SCG PDCP of the SN and the SCG RLS of the SN, and UP path configuration information of the split PDCP of the SN and the split RLC of the SN. Accordingly, when the SN receives the node switch preparation request message, the SN may generate the MCG PDCP instance, the SCG PDCP instance, the split PDCP instance, and the MCG RLS instance according to the included configuration information. In addition, the SN may configure the UP paths of the MCG PDCP of the MN and the MCG RLS of the SN, the UP paths of the SCG PDCP of the SN and the SCG RLS of the SN, and the UP paths of the split PDCP of the SN and the split RLC of the SN according to the configuration information included in the node switch preparation request message.

As another example, referring to FIG. 17H, the node switch preparation request message may include the MCG RLS instance configuration information of the SN. Additionally, the node switch preparation request message may include the UP path configuration information of the MCG PDCP of the SN and the MCG RLS of the SN. Accordingly, when the SN receives the node switch preparation request message, the SN may generate the MCG RLS instance according to the included configuration information. In addition, the SN may configure the UP paths of the MCG PDCP of the MN and the MCG RLS of the SN according to the configuration information included in the node switch preparation request message.

In FIGS. 17A to 17H, the node switch preparation request message may include the MCG PDCP, the SCG PDCP, and the split PDCP generated in the SN and the UP path configuration information with the CN. Accordingly, the SN may configure the UP path according to the UP path configuration information between the MCG PDCP, the SCG PDCP, and the split PDCP and the CN generated according to the node switch preparation request message.

Meanwhile, when the MCG/SCG/split is MN-terminated in the MN, the corresponding MN-terminated MCG/SCG/split may set the UP path of the SN-CN of the RAN and the UP path of the SN-CN of the RAN in order to achieve the SN termination. To this end, the SN may include UP information of the MN-CN of the RAN acquired from the node switch preparation request message in the node switch preparation request message and transmit the UP information to the AMF (S3203). Then, the AMF may receive the node switch complete request message from the SN. In this case, the node switch preparation request message received by the AMF may include DL UP information of the SN. Accordingly, the AMF may map and manage the DL TNL address of the MN/DL TEID of the MN and the DL TNL address of the SN/DL TEID of the SN to one UL TNL address. Alternatively, the AMF may manage the UL TNL address/UL TEID differently for the MN and the SN. Of course, the AMF may manage the UL TNL address/UL TEID differently for the MN and the SN.

Accordingly, the AMF may transmit the mapped information of the DL TNL address of the MN/DL TEID of the MN and the DL TNL address of the SN/DL TEID of the SN to one UL TNL address and the UL TEID to the SN though the node switch preparation request acknowledge message (S3204). Then, the SN may receive the node switch preparation request acknowledge including the mapped information of the DL TNL address of the MN/DL TEID of the MN and the DL TNL address of the SN/DL TEID of the SN to the UL TNL address of the CN and the UL TEID. The SN may store and manage the mapped information of the DL TNL address of the MN/DL TEID of the MN and the DL TNL address of the SN/DL TEID of the SN to the received UL TNL address and UL TEID of the CN. The CN and SN may share all of the information to know which QoS flows may be MN-terminated, and at the same time, SN-terminated.

Meanwhile, the SN may generate the RRC connection reconfiguration message including newly generated instance information so that an instance corresponding to the newly generated instance may be generated in the terminal, and transmit the generated RRC connection reconfiguration message to the terminal (S3205). In this case, the SN may provide the newly set path information by the newly set instance to the terminal. Then, the terminal may receive the RRC connection reconfiguration message including the newly generated instance information from the SN. The terminal may generate an instance corresponding to the instance generated in the SN according to the RRC connection reconfiguration message including the newly generated instance information received. In addition, the terminal may receive the newly set path information from the SN and check the path of the user data. Accordingly, the terminal may transmit the RRC connection reconfiguration complete message to the SN (S3206). Then, the SN may receive the RRC connection reconfiguration complete message from the terminal and confirm the generation of the corresponding instance at the terminal.

Meanwhile, in the case of the SDS from the active MN to the SN, from the network perspective, the CN may have two DL/UP information for the MCG/SCG/split bearers. Similarly, the terminal may transmit the user data to the MN PDCP or the SN PDCP or perform bicasting with the user data to both paths. Therefore, the CN may have the MN DL/UL path for the QoS flows related to the MCG/SCG/split bearers and the DL/UL path of the SN, through the mutual exchange of the messages. Likewise, the terminal may be connected to the MN PDCP or the SN PDCP in relation to the MCG/SCG/split bearers. The terminal and the CN UPF may exchange configurations for NAS PDCP configuration for bicasting for UL and DL transmission with each other using the messages.

In other words, the AMF may transmit the node switch preparation request message to the SN (S3207). The node switch preparation request message may include the mapped information of the DL TNL address of the MN/DL TEID of the MN and the DL TNL address of the SN/DL TEID of the SN to the UL TNL address and the UL TEID of the AMF. Then, the SN may receive the node switch preparation request message from the AMF.

Thereafter, the SN may transmit the node switch preparation request message to the terminal (S3208). The node switch preparation request message may include the mapped information of the DL TNL address of the MN/DL TEID of the MN and the DL TNL address of the SN/DL TEID of the SN to the UL TNL address and the UL TEID of the AMF. Then, the terminal may receive the node switch preparation request message from the SN.

Then, the terminal may transmit the node switch preparation request acknowledge message to the SN (S3209). The node switch preparation request acknowledge message may include the configurations for the NAS PDCP configuration to be connected to the MN PDCP or to connect to the SN PDCP in relation to the MCG/SCG/split bearers. Accordingly, the SN may receive the node switch preparation request acknowledge message from the terminal. Then, the SN may transmit the node switch preparation request acknowledge message to the AMF (S3210). The AMF may receive the node switch preparation request acknowledge message from the SN. The node switch preparation request acknowledge message may include the configurations for the NAS PDCP configuration to be connected to the MN PDCP or to connect to the SN PDCP in relation to the MCG/SCG/split bearers.

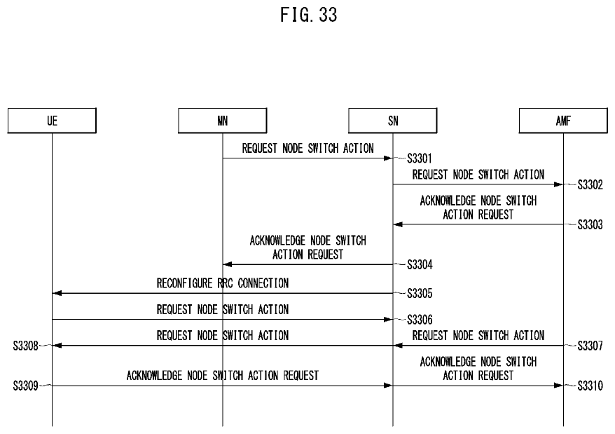

FIG. 33 is a flowchart illustrating a first embodiment of the node switching action operation of FIG. 31.

Referring to FIG. 33, in the node switching action operation, the MN may transmit the node switch action request message to the SN (S3301). Then, the SN may receive the node switch action request message from the MN. Then, the SN may transmit the node switch action request message (S3302). In this case, the SN may transmit the RAN UE NGAP ID (MN) received by the MN and the RAN UE NGAP ID (SN) generated based on the AMF UE NGAP ID to the AMF. Then, the AMF may receive the node switch action request message including the RAN UE NGAP ID (SN) from the SN. The AMF may replace the RAN UE NGAP ID (MN) with the RAN UE NGAP ID (SN). Thereafter, the AMF may transmit the node switch action request acknowledge message to the SN (S3303). The SN may receive the node switch action request acknowledge message from the AMF. The SN may transmit the node switch action request acknowledge message to the MN (S3304). Accordingly, the MN may determine the performance of the SDS by receiving the node switch action request acknowledge message from the SN.

Accordingly, in the case of FIGS. 15A to 15H and 17A to 17H, the MN may block data transmission as in an original character including letter X. This data transmission blocking may be performed when the node switch action request acknowledge message is successfully received from the SN.

Meanwhile, the SN may generate the RRC connection reconfiguration message including newly generated instance information so that an instance corresponding to the newly generated instance may be generated in the terminal, and transmit the generated RRC connection reconfiguration message to the terminal (S3305). In this case, the SN may provide the newly set path information by the newly set instance to the terminal. Then, the terminal may receive the RRC connection reconfiguration message including the newly generated instance information from the SN. The terminal may generate an instance corresponding to the instance generated in the SN according to the RRC connection reconfiguration message including the newly generated instance information received. In addition, the terminal may receive the newly set path information from the SN and check the path of the user data. Accordingly, the terminal may transmit the RRC connection reconfiguration complete message to the SN (S3306). Then, the SN may receive the RRC connection reconfiguration complete message from the terminal and confirm the generation of the corresponding instance at the terminal.

Meanwhile, the AMF may transmit the node switch action request signal to the SN (S3307). The node switch action request message may include the mapped information of the DL TNL address of the MN/DL TEID of the MN and the DL TNL address of the SN/DL TEID of the SN to the UL TNL address and the UL TEID of the AMF. Then, the SN may receive the node switch action request message from the AMF.

Thereafter, the SN may transmit the node switch action request message to the terminal (S3308). The node switch action request message may include the mapped information of the DL TNL address of the MN/DL TEID of the MN and the DL TNL address of the SN/DL TEID of the SN to the UL TNL address and the UL TEID of the AMF. Then, the terminal may receive the node switch action request message from the SN.

Then, the terminal may transmit the node switch action request acknowledge message to the SN (S3309). The node switch action request acknowledge message may include the configurations for the NAS PDCP configuration to be connected to the MN PDCP or to connect to the SN PDCP in relation to the MCG/SCG/split bearers. Accordingly, the SN may receive the node switch action request acknowledge message from the terminal. Then, the SN may transmit the node switch action request acknowledge message to the AMF (S3310). The AMF may receive the node switch action request acknowledge message from the SN. The node switch action request acknowledge message may include the configurations for the NAS PDCP configuration to be connected to the MN PDCP or to connect to the SN PDCP in relation to the MCG/SCG/split bearers.

In the case of the SDS from the active MN to the SN through the mutual exchange of the node switch action request and node switch action request acknowledge messages, the CN may switch all downlink QoS flows related to the MN termination of the MCG/SCG/split to the SN termination. Alternatively, the CN may perform the bicasting of all the DL QoS flows related to the MN termination of the MCG/SCG/split through the NAS PDCP by receiving the node switch action request acknowledge message. The terminal may switch all the UL QoS flows related to the MCG/SCG/split bearers from the MN PDCP to the SN PDCP. Alternatively, the terminal may perform the bicasting of the UL QoS flows related to the MCG/SCG/split bearers through the NAS PDCP by transmitting the node switch action request acknowledge message. Meanwhile, in the case of handover (in other words, in the case of smooth fading in/handover out) using smart switching from the MN to the SN, the MN may be the SN and the SN may be the MN. Accordingly, the UP paths remaining in the previous SN may be performed through SN node modification and deletion procedures.

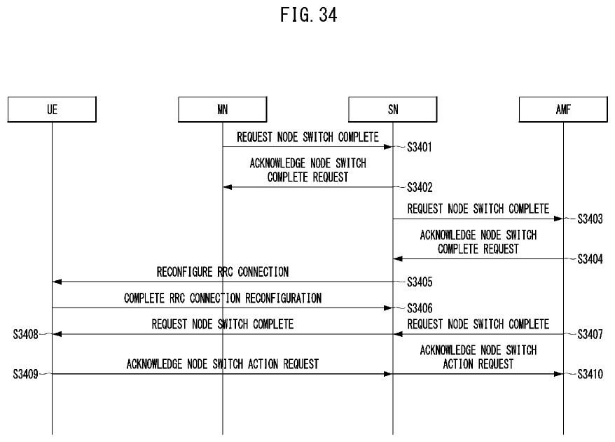

FIG. 34 is a flowchart illustrating a first embodiment of the node switching complete operation of FIG. 31.

Referring to FIG. 34, in the node switching complete operation, the SN may transmit the node switch complete request message to the MN (S3401). Then, the MN may receive the node switch complete request message from the SN. In this case, the MN may delete the MCG PDCP, the SCG PDCP, or the split PDCP therein. The MN may delete the MCG RLS therein. In addition, the MN may delete the internal path and the path with the SN in the linked MN related to the instance. Thereafter, the MN may transmit the node switch complete request acknowledge message to the SN (S3402). Then, the SN may receive the node switch complete request acknowledge message from the MN.

Then, the SN may transmit the node switch complete request message to the AMF. Then, the AMF may receive the node switch complete request message from the SN. The AMF may delete the RAN UE NGAP ID related to the MN from the control information related to the MN-CN control interface of the RAN on the MN and the CP. Of course, the MN may delete the RAN UE NGAP ID related to the MN from the control information related to the MN-CN control interface of the RAN. Meanwhile, the AMF may delete UP information related to the MCG/SCG/split bearer between the MN and the CN. Accordingly, the AMF may transmit the node switch complete request acknowledge message to the SN. Then, the SN may receive the node switch complete request acknowledge message from the AMF.

Meanwhile, the SN may transmit the RRC connection reconfiguration message to the terminal (S3405). Then, the terminal may receive the RRC connection reconfiguration message from the SN. The terminal may delete instances corresponding to the MCG PDCP, the SCG PDCP, or the split PDCP of the MN. The terminal may delete instances corresponding to the MCG RLS of the MN. In addition, the terminal may delete the internal paths of the linked terminal associated with these instances. Thereafter, the terminal may transmit the RRC connection reconfiguration acknowledge message to the SN (S3406). Then, the SN may receive the RRC connection reconfiguration acknowledge message from the terminal.

Meanwhile, the AMF may transmit the node switch complete request signal to the SN (S3407). Then, the SN may receive the node switch complete request signal from the AMF. Accordingly, the SN may transmit the node switch complete request signal to the terminal (S3408). Then, the terminal may receive the node switch complete request signal from the SN.

Meanwhile, the terminal may transmit the node switch action complete acknowledge signal to the SN (S3409). Then, the SN may receive the node switch action complete acknowledge signal from the terminal. Accordingly, the SN may transmit the node switch action complete acknowledge signal to the AMF (S3410). Then, the AMF may receive the node switch complete acknowledge signal from the SN.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
adding the first communication node as a primary secondary cell (PSCell) to a second communication node through dual connectivity (DC);
generating a first user plane path for smart dynamic switching (SDS) and a first instance for supporting the first user plane path according to a request from the second communication node;
transmitting information on the first user plane path and the first instance to a terminal;
receiving user data based on the first user plane path from the terminal as the first instance; and
transmitting the user data to a core network using the first user plane path.

2. The method of claim 1, wherein the generating of the first user plane path for the SDS and the first instance for supporting the first user plane path according to the request from the second communication node includes:
receiving an SDS preparation request including configuration information of the first user plane path and configuration information of the first instance for the SDS from the second communication node;
generating the first user plane path according to the configuration information of the first user plane path;
generating the first instance to support the first user plane path according to the configuration information of the first instance; and
transmitting a smart dynamic preparation request acknowledge including information on the configured first instance to the second communication node.

3. The method of claim 1, wherein the first instance is a master cell group (MCG) radio link control (RLC) instance, and
the first user plane path is a user plane path generated between an MCG packet data convergence protocol (PDCP) instance of the second communication node and the MCG RLC instance.

4. The method of claim 3, further comprising:
receiving downlink user data of an MCG bearer from the MCG PDCP of the second communication node; and
transmitting the downlink user data to the terminal using the MCG RLC.

5. The method of claim 1, wherein the first instance is an MCG RLC instance, and
the first user plane path is a user plane path generated between an MCG PDCP instance of the first communication node and the MCG RLC instance.

6. The method of claim 5, further comprising:
receiving downlink user data of an MCG bearer from a core network using the MCG PDCP instance; and
transmitting the downlink user data to the terminal using the MCG RLC instance.

7. The method of claim 1, wherein the request from the second communication node further includes a core network for the SDS, control interface configuration information of the first communication node, and bearer information terminated in the second communication node, and
the method further includes:
setting a control interface between the core network and the first communication node according to the control interface configuration information; and
generating bearers terminated in the first communication node that replaces bearers terminated in the second communication node based on the bearer information terminated in the second communication node.

8. The method of claim 7, wherein the control interface configuration information includes information on a first terminal identifier for the terminal generated by the second communication node and information on a second terminal identifier for the terminal generated by the core network, and
the setting of the control interface between the core network and the first communication node according to the control interface configuration information includes:
generating a third terminal identifier based on the first terminal identifier and the second terminal identifier;
transmitting an SDS preparation request including the first terminal identifier, the second terminal identifier, and the third terminal identifier to the core network; and
receiving mapping information between the second terminal identifier and the third terminal identifier from the core network.

9. The method of claim 7, wherein the request from the second communication node further includes the control interface and information on second instances for supporting the bearers terminated in the first communication node, and
the method further includes:
generating the control interface and the second instances for supporting the bearers terminated in the first communication node;
generating second user plane paths according to the second instances;
transmitting the second user plane paths and the information on the second instances to the terminal;
receiving the user data based on the second user plane paths from the terminal to the second instances; and
transmitting the user data to the core network using the second user plane paths.

10. The method of claim 9, wherein the second instances are an MCG PDCP instance, a secondary cell group (SCG) PDCP instance, a split PDCP instance and an MCG RLC instance when the bearers terminated in the first communication node are an MCG bearer, an SCG bearer, and a split bearer, and
the second user plane paths include a path via the MCG PDCP instance and the MCG RLC instance, a path via the SCG PDCP instance and the SCG RLC instance, and a path via the split PDCP instance and the split RLC instance.

11. The method of claim 7, further comprising:
receiving downlink user data of an MCG bearer or an SCG bearer from the core network through the control interface;
transmitting the downlink user data to the terminal;
receiving downlink user data of a split bearer from the core network through the control interface; and
transmitting the downlink user data to the terminal.

12. A method of a terminal, comprising:
connecting the terminal to a first communication node added as a primary secondary cell (PSCell) to a second communication node through dual connectivity (DC);
receiving a first user plane path for smart dynamic switching (SDS) and information on a first instance for supporting the first user plane path from the first communication node; and
generating a second instance corresponding to the first instance.

13. The method of claim 12, further comprising:
generating user data via the first user plane path; and
transmitting the user data as the first instance using the second instance.

14. The method of claim 12, further comprising:
receiving information on bearers terminated in the first communication node that replaces bearers terminated in the second communication node and information on second user plane paths related to bearers terminated in the first communication node;
generating user data via the second user plane path; and
transmitting the user data to the first communication node.

15. A first communication node comprising:
a processor,
wherein the processor operates to cause the first communication node to:
be added, as a primary secondary cell (PSCell), to a second communication node through dual connectivity (DC);
generate a first user plane path for smart dynamic switching (SDS) and a first instance for supporting the first user plane path according to a request from the second communication node;
transmit the first user plane path and information on the first instance to a terminal;
receive user data based on the first user plane path from the terminal as the first instance; and
transmit the user data to a core network using the first user plane path.

16. The first communication node of claim 15, wherein, in the generation of the first user plane path for the SDS and the first instance for supporting the first user plane path according to the request from the second communication node, the processor operates to cause the first communication node to:
receive an SDS preparation request including configuration information of the first user plane path and configuration information of the first instance for the SDS from the second communication node;
generate the first user plane path according to the configuration information of the first user plane path;
generate the first instance for supporting the first user plane path according to the configuration information of the first instance; and
transmit a smart dynamic preparation request acknowledge including information on the configured first instance to the second communication node.

17. The first communication node of claim 15, wherein the request from the second communication node further includes a core network for the SDS, control interface configuration information of the first communication node, and bearer information terminated in the second communication node, and
the processor operates to cause the first communication node to:
set the control interface between the core network and the first communication node according to the control interface configuration information; and
generate bearers terminated in the first communication node that replaces bearers terminated in the second communication node based on the bearer information terminated in the second communication node.

18. The first communication node of claim 17, wherein the control interface configuration information includes information on a first terminal identifier for the terminal generated by the second communication node and information on a second terminal identifier for the terminal generated by the core network, and
in the setting of the control interface between the core network and the first communication node according to the control interface configuration information, the processor operates to cause the first communication node to:
generate a third terminal identifier based on the first terminal identifier and the second terminal identifier;
transmit an SDS preparation request including the first terminal identifier, the second terminal identifier, and the third terminal identifier to the core network; and
receive mapping information between the second terminal identifier and the third terminal identifier from the core network.
